(19) United States
(12) Patent Application Publication
(10) Pub. No.: US 2015/0054212 A1
(43) Pub. Date: Feb. 26, 2015

(54) SHEET DISCRIMINATING DEVICE AND SHEET PROCESSING APPARATUS

(71) Applicant: Kabushiki Kaisha Toshiba, Tokyo (JP)

(72) Inventors: Hiroaki Fujihara, Kanagawa-ken (JP); Seiji Ikari, Kanagawa-ken (JP); Tomonori Makino, Tokyo (JP); Masakazu Itoya, Kanagawa-ken (JP); Masahiro Nagao, Kanagawa-ken (JP); Naoki Hori, Kanagawa-ken (JP); Junji Miura, Kanagawa-ken (JP)

(21) Appl. No.: 14/463,173

(22) Filed: Aug. 19, 2014

(30) Foreign Application Priority Data
Aug. 20, 2013 (JP) 2013-170795
Aug. 20, 2013 (JP) 2013-170796

(51) Int. Cl. B65H 7/20; B07C 5/342; B65H 5/26; B65H 7/06; B65H 5/02; B65H 5/06

(52) U.S. Cl. CPC B65H 7/20; B65H 5/023; B65H 5/068; B65H 5/26; B65H 7/06; B07C 5/342
USPC 271/3.2; 271/265.04; 271/227

(57) ABSTRACT

According to one embodiment, a sheet discriminating device includes a first conveying structure and a second conveying structure that are arranged at a predetermined distance from each other in a conveying direction of a sheet and that are configured to convey the sheet, and an information detecting means that is provided between the first conveying structure and the second conveying structure such that a detection range thereof is not blocked, and that is configured to detect information from the sheet.

### CROSS-REFERENCE TO RELATED APPLICATIONS

This application is based upon and claims the benefit of priority from Japanese Patent Application Nos. 2013-170795, filed on Aug. 20, 2013 and 2013-170796, filed on Aug. 20, 2013; the entire contents of which are incorporated herein by reference.

### FIELD

Embodiments described herein relate generally to a sheet discriminating device and a sheet processing apparatus.

### BACKGROUND

Conventionally, there is known a technology of conveying a sheet in an unconstrained state and acquiring an optical image of the sheet using an optical sensor in order to discriminate the sheet while conveying the sheet.

However, if a sheet in an unconstrained state is guided using a fixed guide, frictional resistance between the sheet and the fixed guide reduces the conveyance speed of the sheet and may lead to a conveyance failure. Also, even if a light-transmittable fixed guide is used for the optical sensor, there are cases where the light transmissivity decreases due to adhesion of dust and the like, a stain, and the like, and the image of the sheet may not be obtained in a continuously stable state.

### BRIEF DESCRIPTION OF THE DRAWINGS

FIG. 1 is a side view schematically showing a sheet discriminating device according to a first embodiment when seen in a direction that is parallel to a conveyance reference plane and orthogonal to a conveying direction;

FIG. 2 is a side view schematically showing the configuration of the sheet discriminating device according to the first embodiment when the side of a photo receiver of an image detecting device is seen from the side of a light emitter thereof in a direction that is normal to the conveyance reference plane;

FIG. 3 is a side view schematically showing the configuration of the sheet discriminating device according to the first embodiment when seen in the direction that is parallel to the conveyance reference plane and orthogonal to the conveying direction, and shows a state in which only a rear end side of a sheet is retained and a state in which a front end side and the rear end side of the sheet are retained;

FIG. 4 is a side view schematically showing the configuration of the sheet discriminating device according to the first embodiment when seen in the direction that is parallel to the conveyance reference plane and orthogonal to the conveying direction, and shows a state in which only the front end side of a sheet is retained;

FIG. 5 is a side view schematically showing the configuration of a sheet discriminating device according to a first modification of the first embodiment when seen from the direction that is parallel to the conveyance reference plane and orthogonal to the conveying direction;

FIG. 6 is a side view schematically showing the configuration of the sheet discriminating device according to the first modification of the first embodiment when the side of the photo receiver of the image detecting device is seen from the side of the light emitter thereof in the direction that is normal to the conveyance reference plane;

FIG. 7 is a side view schematically showing the configuration of a sheet discriminating device according to a second modification of the first embodiment when the side of the photo receiver of the image detecting device is seen from the side of the light emitter thereof in the direction that is normal to the conveyance reference plane;

FIG. 8 is a side view schematically showing the configuration of a sheet discriminating device according to a third modification of the first embodiment when seen in the direction that is parallel to the conveyance reference plane and orthogonal to the conveying direction;

FIG. 9 is a perspective view schematically showing an external appearance of a sheet processing apparatus that includes the sheet discriminating device according to the first embodiment;

FIG. 10 is a configuration diagram schematically showing an internal configuration of the sheet processing apparatus that includes the sheet discriminating device according to the first embodiment;

FIG. 11 is a block diagram schematically showing the configuration of a control system of the sheet processing apparatus that includes the sheet discriminating device according to the first embodiment;

FIG. 12 is a side view schematically showing the configuration of a sheet discriminating device according to a second embodiment when seen in the direction that is parallel to the conveyance reference plane and orthogonal to the conveying direction;

FIG. 13 is a side view schematically showing the configuration of the sheet discriminating device according to the second embodiment when seen in the direction that is normal to the conveyance reference plane;

FIG. 14 is an enlarged configuration diagram showing a first guide member and a second guide member in an enlarged manner, the first and second guide members being shown in FIG. 12;

FIG. 15 is a side view schematically showing the configuration of a sheet discriminating device according to a first modification of the second embodiment when seen in the direction that is parallel to the conveyance reference plane and orthogonal to the conveying direction;

FIG. 16 is a side view schematically showing the configuration of a sheet discriminating device according to a second modification of the second embodiment when seen in the direction that is parallel to the conveyance reference plane and orthogonal to the conveying direction;

FIG. 17 is a side view schematically showing the configuration of a sheet discriminating device according to the second modification of the second embodiment when seen in the direction that is parallel to the conveyance reference plane and orthogonal to the conveying direction;

FIG. 18 is a side view schematically showing the configuration of a sheet discriminating device according to a third modification of the second embodiment when seen in the direction that is parallel to the conveyance reference plane and orthogonal to the conveying direction;

FIG. 19 is a side view schematically showing the configuration of a sheet discriminating device according to the third modification of the second embodiment when seen in the direction that is parallel to the conveyance reference plane and orthogonal to the conveying direction; and

FIG. 20 is a side view schematically showing the configuration of a sheet discriminating device according to a fourth variation of the second embodiment when seen in the direction that is parallel to the conveyance reference plane and orthogonal to the conveying direction.

### DETAILED DESCRIPTION

According to one embodiment, there is provided a sheet discriminating device including a first conveying structure and a second conveying structure that are arranged at a predetermined distance from each other in a conveying direction of a sheet and that are configured to convey the sheet; and an information detecting means that is provided between the first conveying structure and the second conveying structure such that a detection range thereof is not blocked, and that is configured to detect information from the sheet, wherein a first entry angle θ1 that is formed by a first entry direction in which the sheet enters a space between the first conveying structure and the second conveying structure from the first conveying structure and a conveyance reference plane that is set between the first conveying structure and the second conveying structure, and a second entry angle θ2 that is formed by a second entry direction in which the sheet enters the second conveying structure from the space between the first conveying structure and the second conveying structure and the conveyance reference plane are set to be equal to or less than respective predetermined values that depend on positions of the first conveying structure, the second conveying structure, and the information detecting means and a distance up to which the sheet is allowed to be separated from the conveyance reference plane at the position of the information detecting means.

Referring to the accompanying drawings, the following is a description of sheet discriminating devices and sheet processing apparatuses according to embodiments.

(Configuration of Sheet Processing Apparatus)

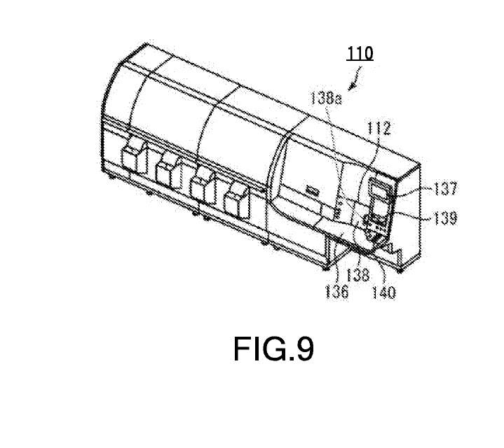

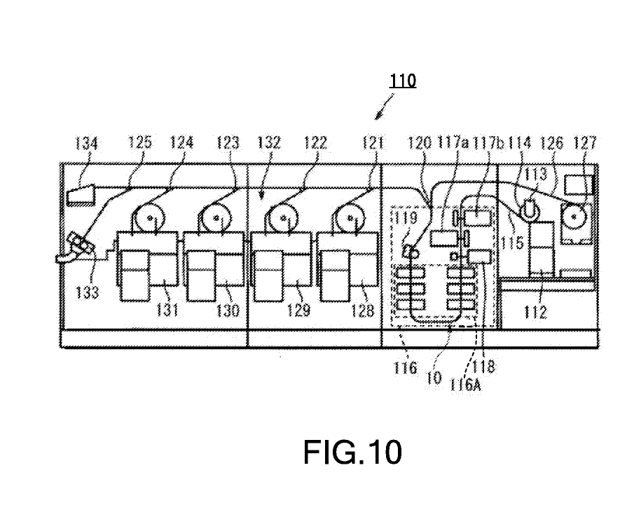

FIGS. 9 and 10 are diagrams schematically showing an external appearance and inner configuration of a sheet processing apparatus 110 that includes a sheet discriminating device 10 according to an embodiment. This sheet processing apparatus 110 inspects, for example, banknotes delivered from branches of a plurality of banks as sheets to be processed, binds only the banknotes that are fit for reuse into bundles, and provides those banknotes for reuse.

As shown in FIGS. 9 and 10, the sheet processing apparatus 110 includes a supplying portion 112 in a first end portion thereof in a first direction (e.g., width direction etc.), in which a stack of a plurality of banknotes can be placed. The sheet processing apparatus 110 includes a take-out portion 113 above the supplying portion 112, from which the plurality of stacked banknotes that are placed in the supplying portion 112 are taken out successively and one by one in such a manner that the top (e.g., uppermost) banknote in a stacking direction is taken out at each time. The take-out portion 113 includes a suction roller 114 that comes into contact with a single uppermost banknote and rotates while suctioning this banknote using negative pressure. The suction roller 114 can take out, for example, one banknote every time the suction roller 114 makes one revolution, and takes out the plurality of stacked banknotes successively and one by one at regular time intervals.

The sheet processing apparatus 110 includes a banknote conveying path 115 that extends from the take-out portion 113 toward a downstream side in the taking-out direction. The conveying path 115 includes a conveying belt (not shown), a drive pulley (not shown), a motor (not shown) for moving the conveying belt, and the like, and conveys the banknotes that have been taken out by the suction roller 114 at a constant speed.

The sheet processing apparatus 110 includes an inspection portion 116 that detects optical and magnetic feature information on a banknote that is being conveyed on the conveying path 115 and inspects the type of the banknote, whether or not the banknote is soiled/mutilated, the front and back of the banknote, the authenticity of the banknote, and the like. If a banknote is soiled/mutilated, this means a state in which the banknote is dirty, torn, or bent. The inspection portion 116 includes a first and a second image reader 117a and 117b that are arranged so as to be able to read images on a front surface and a back surface, respectively, of a banknote that is being conveyed on the conveying path 115. Each of the first and second image readers 117a and 117b includes, for example, an imaging device such as a CCD camera, and reads a pattern image on the front surface or the back surface of a banknote from images obtained by performing imaging using this imaging device. The inspection portion 116 includes a shape/watermark detection device 118 that detects the shape, a watermark image, and the like of a banknote that is being conveyed on the conveying path 115. The inspection portion 116 includes a magnetic detecting device 116A that detects the magnetic feature information on a banknote that is being conveyed on the conveying path 115. The inspection portion 116 includes a thickness inspection portion 119 that inspects the thickness of a banknote that is being conveyed on the conveying path 115. The thickness inspection portion 119 determines whether or not a plurality of banknotes have been taken out at one time in an overlapping state by the take-out portion 113 based on the thickness of the banknote to be inspected.

The sheet processing apparatus 110 includes, for example, a first to a sixth gate 120 to 125 that are sequentially arranged on the conveying path 115 downstream of the inspection portion 116 in a conveying direction of the banknotes. Each of the first to sixth gates 120 to 125 switches a guiding direction of the banknotes in response to control that is based on the inspection results of the inspection portion 116. The first gate 120 that is provided directly downstream of the inspection portion 116 in the conveying direction of the banknotes is arranged at a branch point where a rejection sheet conveying route 126 branches off from the conveying path 115. The first gate 120 guides rejection sheets that have been determined not to be proper banknotes by the inspection portion 116, uninspectable sheets that could not be inspected by the inspection portion 116, and the like to the rejection sheet conveying route 126.

The sheet processing apparatus 110 includes a rejection sheet stacker 127 in a terminal portion of the rejection sheet conveying route 126. In the rejection sheet stacker 127, rejection sheets and uninspectable sheets are stacked in a state in which the orientation of the banknotes as taken out by the take-out portion 113 is maintained, that is, a state in which the front and rear of the banknotes are not inverted (actually a state in which the banknotes are rotated 360°) and also in a state in which the order of the plurality of banknotes as taken out by the take-out portion 113 is maintained. In addition to the rejection sheets and uninspectable sheets, the rejection sheet stacker 127 collects uninspectable sheets that are a plurality of banknotes that have been taken out at one time in an overlapping state by the take-out portion 113, counterfeits, and the like.

The sheet processing apparatus 110 includes a first to a fourth stack/band portion 128 to 131 (collectively referred to as “stack/band portion 132”) at respective positions that are made to branch off from the conveying path 115 by the second to fifth gates 121 to 124. In the first to fourth stack/band portions 128 to 131, only fit sheets that are fit for reuse of proper banknotes (i.e., banknotes other than rejection sheets and uninspectable sheets) that are guided to the conveying path 115 by the first gate 120 are stacked and bound together. For example, in each of the first and second stack/band portions 128 and 129, 100 fit sheets with the front surfaces thereof facing upward in the vertical direction are stacked and bound together at one time, while in each of the third and fourth stack/band portions 130 and 131, 100 fit sheets with the rear surfaces thereof facing upward in the vertical direction are stacked and bound together at one time. More specifically, after 100 fit sheets are stacked in the first stack/band portion 128, the next 100 fit sheets are stacked in the second stack/band portion 129 while the previous 100 stacked fit sheets are bound together. Fit sheets that are bound together by the stack/band portion 132 in this manner are discharged to the outside of the sheet processing apparatus 110 by a conveyor (not shown) or the like and provided for reuse.

The sheet processing apparatus 110 includes a cutting portion 133 in a position that is made to branch off from the conveying path 115 by the sixth gate 125, which is arranged on the most downstream side in the conveying direction of the banknotes. The cutting portion 133 cuts unfit sheets that have not been stacked by the stack/band portion 132, that is, banknotes that are proper banknotes but determined to be unfit for reuse because those banknotes are soiled/mutilated, for example, of the proper banknotes guided to the conveying path 115 by the first gate 120 so that the unfit sheets become invalid, and then stores those unfit sheets. Note that if a main controller 151, which will be described later, does not select an unfit sheet cutting mode, the unfit sheets are stacked in a stacker 134 for stacking unfit sheets, instead of being conveyed to the cutting portion 133.

The sheet processing apparatus 110 includes an operating portion 136 that is operable by an operator around the supplying portion 112. The operating portion 136 includes an operation/display panel 137 that accepts various operation inputs from the operator and displays various operation prompts and the like to the operator. The operation/display panel 137 includes, for example, a touch panel that detects an input of a button that is displayed on the screen when the operator touches that button. The sheet processing apparatus 110 includes a door 138 having a handle 138a for opening and closing a banknote feed port of the supplying portion 112, a take-out port 139 through which banknotes that are stacked in the rejection sheet stacker 127 are taken out, a keyboard 140 that is operated by the operator, and the like in the vicinity of the operation/display panel 137.

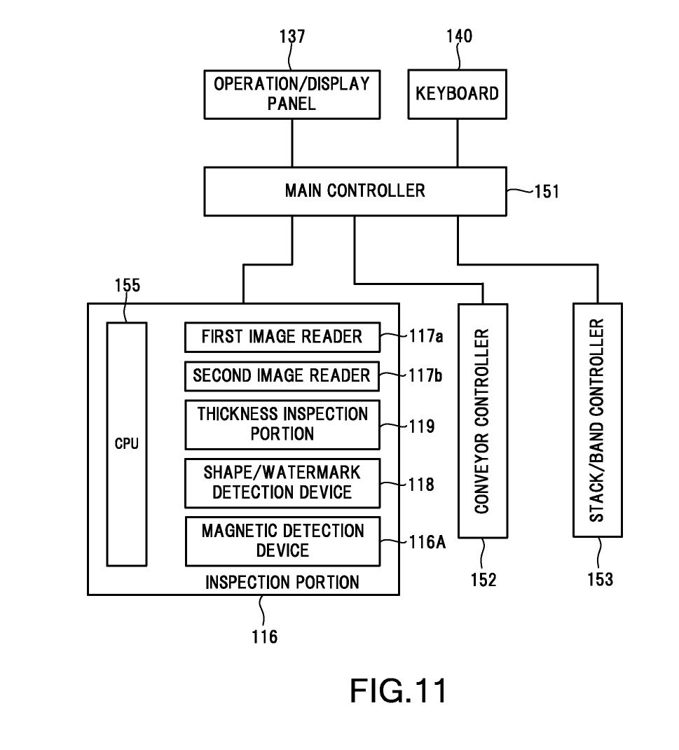

FIG. 11 is a diagram schematically showing the configuration of a control system of the sheet processing apparatus 110 according to the present embodiment. As shown in FIG. 11, the sheet processing apparatus 110 includes the main controller 151 and the inspection portion 116, the operation/display panel 137, and the keyboard 140 that are connected to the main controller 151, as well as a conveyor controller 152 and a stack/band controller 153 that are connected to the main controller 151. The main controller 151 controls each of the conveyor controller 152 and the stack/band controller 153 based on a command that is output from the operation/display panel 137 in response to an operation input from the operator, the inspection results of the inspection portion 116, and the like. The conveyor controller 152 controls the taking out and conveyance of banknotes by controlling the take-out portion 113, the conveying path 115, the rejection sheet conveying route 126, and the first to sixth gates 120 to 125 based on the control of the main controller 151. The stack/band controller 153 controls the stacking and binding of banknotes by controlling the rejection sheet stacker 127 and the first to fourth stack/band portions 128 to 131 based on the control of the main controller 151.

(Operation of Sheet Processing Apparatus)

The sheet processing apparatus 110 according to the present embodiment has the above-described configuration, and the following is a description of the operation of this sheet processing apparatus 110. First, when the door 138 is manually opened by the operator, and a plurality of banknotes that are stacked together are placed in the supplying portion 112, the take-out portion 113 is activated. The take-out portion 113 takes out banknotes successively and one by one from the plurality of stacked banknotes that are placed in the supplying portion 112 onto the conveying path 115 in such a manner that the top banknote in the stacking direction is taken out every time. Then, the conveying belt (not shown), the drive pulley (not shown), and the like of the conveying path 115 convey the banknotes on the conveying path 115 toward the inspection portion 116.

Then, the inspection portion 116 detects the optical and magnetic feature information on a banknote that is being conveyed on the conveying path 115, and inspects the type of the banknote, whether the banknote is soiled/mutilated, the front and back of the banknote, the authenticity of the banknote, and the like. For example, if only one banknote is normally taken out by the take-out portion 113, the first image reader 117a of the inspection portion 116 reads an image of the front surface of that banknote that is being conveyed on the conveying path 115. Furthermore, the second image reader 117b of the inspection portion 116 reads an image of the back surface of that banknote, which is being conveyed on the conveying path 115. Note that if, for example, a plurality of banknotes are taken out in an overlapping state by the take-out portion 113, the first and second image readers 117a and 117b read images of the front surface and the back surface of respective banknotes that are located at both ends in the stacking direction. The first and second image readers 117a and 117b store the images read from banknotes in a memory (not shown) within the inspection portion 116. The images that are stored in this memory are displayed to the operator via the operation/display panel 137, if necessary. In the present embodiment, only images of the banknotes that are stacked in the rejection sheet stacker 127 of the banknotes taken out by the take-out portion 113 are stored in the memory. Note that the images that are stored in the memory can be displayed while being switched by performing a predetermined operation through the operation/display panel 137.

The inspection portion 116 judges whether or not a banknote is a proper banknote based on the images read by the first and second image readers 117a and 117b, the shape and the watermark image of the banknote detected by the shape/watermark detection device 118, the magnetic feature information on the banknote detected by the magnetic detecting device 116A, the thickness of the banknotes inspected by the thickness inspection portion 119, and the like. As a result of this judgement, if the inspection portion 116 judges that the banknote is a proper banknote, the inspection portion 116 further judges whether or not the banknote is a fit sheet that is fit for reuse. As a result of this judgement, if it is judged that the banknote is a fit sheet that is fit for reuse, the main controller 151 switches the guiding direction of the banknote of the first gate 120 to a direction of the conveying path 115 toward the stack/band portion 132. Then, the main controller 151 switches the guiding direction of the banknote of one of the second to fifth gates 121 to 124 to a direction toward one of the first to fourth stack/band portions 128 to 131. Thus, the fit sheet guided to the conveying path 115 via the first gate 120 is stacked in one of the first to fourth stack/band portions 128 to 131.

In the present embodiment, the main controller 151 stacks, for example, fit sheets with respect to which the first image reader 117a has detected the pattern of the front surface, that is, fit sheets that have been conveyed in a state in which the front surface faces upward in the stacking direction in either of the first and second stack/band portions 128 and 129. Also, the main controller 151 stacks fit sheets with respect to which the second image reader 117b has detected the pattern of the back surface, that is, fit sheets that have been conveyed in a state in which the back surface faces downward in the stacking direction in either the third and fourth stack/band portions 130 and 131. The main controller 151 thus makes the orientation of the front and back of fit sheets uniform. The main controller 151, for example, stacks fit sheets whose front surfaces face upward in the stacking direction in the first stack/band portion 128. Then, at the point in time when the number of fit sheets in the first stack/band portion 128 reaches 100, the main controller 151 binds these 100 fit sheets together and starts to stack fit sheets in the second stack/band portion 129, and thus stacks and binds together 100 fit sheets in each of the first and second stack/band portions 128 and 129 alternately.

Also, if the inspection portion 116 judges that the banknote is an unfit sheet that is unfit for reuse, the main controller 151 switches the guiding direction of the banknote (unfit sheet) of the sixth gate 125 to the direction toward the cutting portion 133. Thus, the cutting portion 133 cuts the unfit sheets, thereby making the unfit sheets invalid. Note that the main controller 151 counts the number of fit sheets that are stacked and bound together and the number of unfit sheets that are cut and made invalid, and adds the two numbers together.

Also, if the inspection portion 116 judges that the banknote is not a proper banknote, the main controller 151 switches the guiding direction of the banknote of the first gate 120 to the direction toward the rejection sheet conveying route 126. Furthermore, the inspection portion 116 judges whether or not a banknote that is judged not to be a proper banknote is another type of medium. As a result of this judgement, if it is judged that the banknote that is judged not to be a proper banknote is not another type of medium, that is, if the banknote is judged not to be another type of medium from both of the images respectively read by the first and second image readers 117a and 117b, the inspection portion 116 judges that this banknote is a rejection sheet (e.g., rejection sheet that is counterfeited) that is not a proper banknote, or is a plurality of banknotes that have been taken out in an overlapping state. Accordingly, the main controller 151 stacks the banknotes guided to the rejection sheet conveying route 126 in the rejection sheet stacker 127 as they are. On the other hand, if the inspection portion 116 judges that the banknote that is being conveyed is another type of medium (e.g., contaminant etc.), the main controller 151 stops the conveyance of the banknote and stops the banknote, which is being conveyed, on the rejection sheet conveying route 126. Thus, the banknote (i.e., banknote that is judged to be another type of medium) that is stopped on the rejection sheet conveying route 126 is taken out, checked, and manually disposed of by the operator.

(Configuration of First Embodiment of Sheet Discriminating Device)

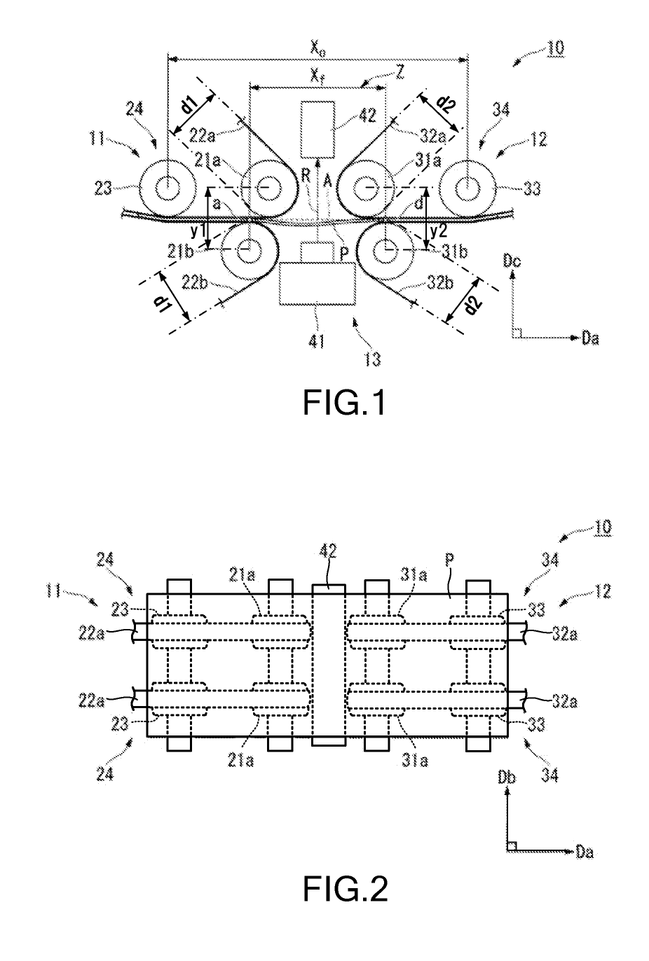

Hereinafter, the sheet discriminating device 10 included in the sheet processing apparatus 110 will be described in detail. FIGS. 1 and 2 schematically show the configuration of the sheet discriminating device 10. The sheet discriminating device 10 of the first embodiment constitutes at least a portion of each of the first and second image readers 117a and 117b of the inspection portion 116 of the sheet processing apparatus 110 described above, and includes a first conveying structure 11, a second conveying structure 12, and the image detecting device 13 as shown in FIGS. 1 and 2.

The first conveying structure 11 and the second conveying structure 12 are arranged at a distance from each other, the distance being shorter than the length of a sheet P to be conveyed, in a conveying direction Da that is parallel to the conveyance reference plane A that is set between the first conveying structure 11 and the second conveying structure 12.

The first conveying structure 11 employs a combination of a pair of a near side first conveying roller 21a and a far side first conveying roller 21b, a pair of a near side first conveying belt 22a and a far side first conveying belt 22b, and a first clamp roller 23 as a single first conveying portion 24, and includes a plurality of, for example, two first conveying portions 24 as shown in FIG. 2. The two first conveying portions 24 are arranged at a predetermined distance from each other in a direction that is parallel to the conveyance reference plane A and orthogonal to the conveying direction Da (i.e., axial direction Db that extends along the width of the sheet P and is parallel to the axes of rotation of the pairs of near side and far side first conveying rollers 21a and 21b).

Each pair of near side and far side first conveying rollers 21a and 21b is arranged such that the axes of rotation of the respective first conveying rollers are parallel to the axial direction Db and are offset from each other in the conveying direction Da. Thus, the near side first conveying roller 21a is arranged so as to be located closer to the second conveying structure 12, and the far side first conveying roller 21b is arranged so as to be located further away from the second conveying structure 12.

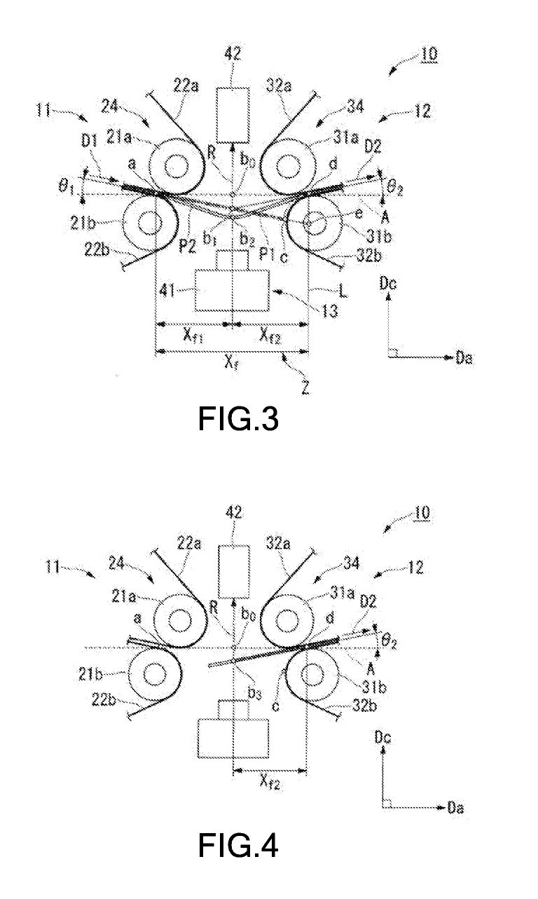

Each pair of near side and far side first conveying belts 22a and 22b is put around the corresponding pair of near side and far side first conveying rollers 21a and 21b, respectively, and turned back in a direction away from the second conveying structure 12. Each pair of near side and far side first conveying belts 22a and 22b is driven by a motor (not shown) or the like in a state in which the two first conveying belts sandwich the sheet P from both sides in the thickness direction between the corresponding pair of near side and far side first conveying rollers 21a and 21b, thereby guiding the sheet P in a first entry direction D1 as shown in FIG. 3. Note that the angle that is formed by the first entry direction D1 in which the sheet P enters the space between the first conveying structure 11 and the second conveying structure 12 from the first conveying structure 11 and the conveying direction Da that is parallel to the conveyance reference plane A is referred to as “first entry angle θ1”.

With respect to each pair of near side and far side first conveying rollers 21a and 21b, the distance (i.e., distance between the respective axes of rotation in a direction that is orthogonal to the first entry direction D1) y1 between the near side and far side first conveying rollers 21a and 21b in the direction that is orthogonal to the first entry direction D1 is set such that a formula (1) below is satisfied, where d1 represents the outer diameters of the pair of near side and far side first conveying rollers 21a and 21b that are equal to each other, t1 represents the thicknesses of the pair of near side and far side first conveying belts 22a and 22b that are equal to each other, and tp represents the thickness of the sheet P. More specifically, the pair of near side and far side first conveying rollers 21a and 21b are arranged such that the pair of near side and far side first conveying belts 22a and 22b are in close contact with each other, or the distance between the pair of near side and far side first conveying belts 22a and 22b is not greater than the thickness tp of the sheet P, which is to be conveyed. Thus, each pair of near side and far side first conveying belts 22a and 22b functions as a movable guide, as it were, and guides the sheet P in the first entry direction D1 while constraining the sheet P.

Formula 1

d1+2×t1≦y1≦d1+2×t1+tp (1)

The first clamp roller 23 is arranged upstream of the pair of near side and far side first conveying rollers 21a and 21b in the conveying path of the sheet P. The pair of near side and far side first conveying belts 22a and 22b that are respectively put around the pair of near side and far side first conveying rollers 21a and 21b and turned back in the direction away from the second conveying structure 12 are wound around the first clamp roller 23. The first clamp roller 23 applies a conveying force in the conveying direction Da to the sheet P by rotating in a state in which the sheet P is sandwiched between the pair of near side and far side first conveying belts 22a and 22b from both sides in the thickness direction.

The second conveying structure 12 employs a combination of a pair of near side and far side second conveying rollers 31a and 31b, a pair of near side and far side second conveying belts 32a and 32b, and a second clamp roller 33 as a single second conveying portion 34, and includes a plurality of, for example, two second conveying portions 34 as shown in FIG. 2. The two second conveying portions 34 are arranged at a predetermined distance from each other in a direction that is parallel to the conveyance reference plane A and orthogonal to the conveying direction Da (i.e., axial direction Db that extends along the width of the sheet P and is parallel to the axes of rotation of the pairs of near side and far side second conveying rollers 31a and 31b). Note that the axis of rotation of a pair of near side first conveying rollers 21a of the first conveying structure 11 and the axis of rotation of a pair of near side second conveying rollers 31a of the second conveying structure 12 are arranged with a distance of preferably 30 to 80 mm interposed therebetween.

Each pair of near side and far side second conveying rollers 31a and 31b is arranged such that the axes of rotation thereof are parallel to the axial direction Db and are offset from each other in the conveying direction Da. Thus, the near side second conveying roller 31a is arranged so as to be located closer to the first conveying structure 11, and the far side second conveying roller 31b is arranged so as to be located further away from the first conveying structure 11.

Each pair of near side and far side second conveying belts 32a and 32b is put around the corresponding pair of near side and far side second conveying rollers 31a and 31b, respectively, and turned back in a direction away from the first conveying structure 11. The pair of near side and far side second conveying belts 32a and 32b is driven by a motor (not shown) or the like in a state in which the two second conveying belts sandwich the sheet P from both sides in the thickness direction between the pair of near side and far side second conveying rollers 31a and 31b, thereby guiding the sheet P in a second entry direction D2 as shown in FIG. 3. Note that the angle that is formed by the second entry direction D2 in which the sheet P enters the second conveying structure 12 from the space between the first conveying structure 11 and the second conveying structure 12 and the conveying direction Da that is parallel to the conveyance reference plane A is referred to as “second entry angle θ2”.

With respect to each pair of near side and far side second conveying rollers 31a and 31b, the distance (i.e., distance between the axes of rotation in a direction that is orthogonal to the second entry direction D2) y2 between the pair of near side and far side second conveying rollers 31a and 31b in the direction that is orthogonal to the second entry direction D2 is set such that a formula (2) below is satisfied, where d2 represents the outer diameters of the pair of near side and far side second conveying rollers 31a and 31b, respectively, that are equal to each other, t2 represents the thicknesses of the pair of near side and far side second conveying belts 32a and 32b that are equal to each other, and tp represents the thickness of the sheet P. More specifically, the pair of near side and far side second conveying rollers 31a and 31b are arranged such that the pair of near side and far side second conveying belts 32a and 32b are in close contact with each other, or the distance between the pair of near side and far side second conveying belts 32a and 32b is not greater than the thickness tp of the sheet P, which is to be conveyed. Thus, each pair of near side and far side second conveying belts 32a and 32b functions as a movable guide, as it were, and guides the sheet P in the second entry direction D2 while constraining the sheet P.

Formula 2

d2+2×t2≦y2≦d2+2×t2+tp (2)

The second clamp roller 33 is disposed downstream of the pair of near side and far side second conveying rollers 31a and 31b in the conveying path of the sheet P. The pair of near side and far side second conveying belts 32a and 32b that are respectively put around the pair of near side and far side second conveying rollers 31a and 31b and turned back in the direction away from the first conveying structure 11 are wound around the second clamp roller 33. The second clamp roller 33 applies a conveying force in the conveying direction Da to the sheet P by rotating in a state in which the sheet P is sandwiched between the pair of near side and far side second conveying belts 32a and 32b from both sides in the thickness direction.

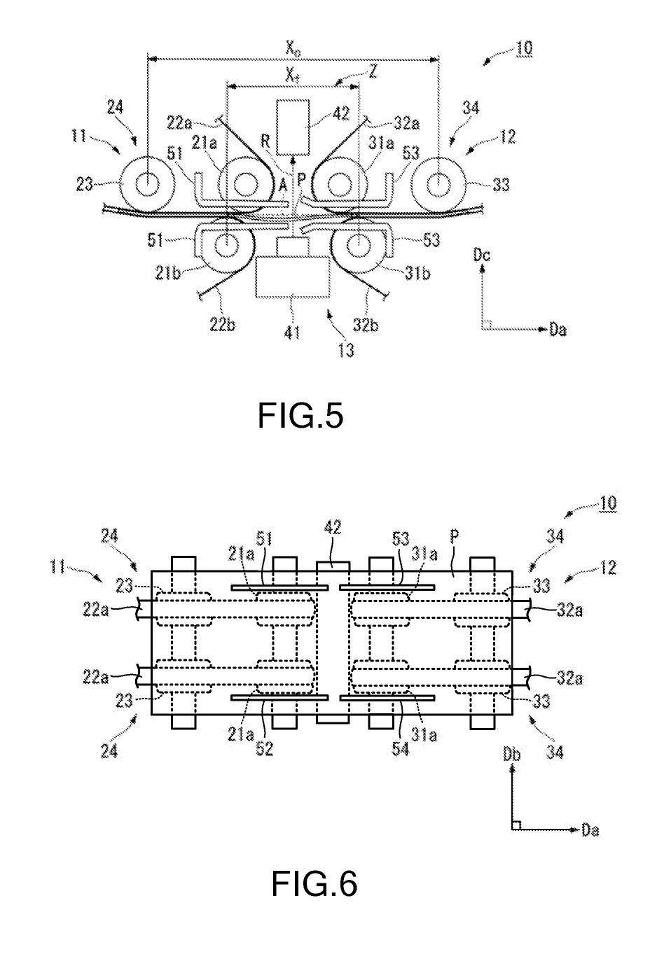

In the first conveying structure 11 and the second conveying structure 12, the peripheral speed of each pair of near side and far side first conveying belts 22a and 22b in association with rotation of the corresponding pair of near side and far side first conveying rollers 21a and 21b and the peripheral speed of each pair of near side and far side second conveying belts 32a and 32b in association with rotation of the corresponding pair of near side and far side first conveying rollers 21a and 21b are set to be equal to each other. In the first conveying structure 11 and the second conveying structure 12, a region between a terminal position “a” at which the sheet P is sandwiched between each pair of near side and far side first conveying belts 22a and 22b and a start position “d” at which the sheet P is sandwiched between the corresponding pair of near side and far side second conveying belts 32a and 32b is referred to as “non-retaining region Z” in which the sheet P is not retained. Also, the position and shape of the sheet P in this non-retaining region Z are maintained in a predetermined state that depends on the rigidity of the sheet P itself, the air resistance, and the like. In the first conveying structure 11 and the second conveying structure 12, the distance Xₒ (FIG. 5) between each first clamp roller 23 and the corresponding second clamp roller 33, which apply the conveying force to the sheet P, is set to be shorter than the length of the sheet P. Thus, at least either of the first conveying structure 11 and the second conveying structure 12 continuously applies the conveying force to the sheet P that is being conveyed.

The image detecting device 13 includes a light emitter 41 and a photo receiver 42 that are arranged facing each other so as to sandwich the conveyance reference plane A from both sides in the direction (i.e., orthogonal direction Dc that is orthogonal to the conveyance reference plane A) of the plane of the sheet P that is conveyed to the non-retaining region Z. The image detecting device 13 is provided such that its detection range in the non-retaining region Z is not blocked, and detects optical feature information (optical information, for example, a transmitted image of the sheet P across the entire width thereof) of the sheet P using transmitted light that is obtained by the sheet P transmitting light emitted from the light emitter 41 toward a focus position b₀ serving as a detection reference point. In the image detecting device 13, the accuracy of the position of the sheet P in the orthogonal direction Dc between the light emitter 41 and the photo receiver 42 which is required in order to discriminate the sheet P is referred to as “conveyance position accuracy Yg”. In the image detecting device 13, the distance between the terminal position “a” at which the sheet P is sandwiched between each pair of near side and far side first conveying belts 22a and 22b and the focus position b₀ is referred to as “first distance X_{f1}”. In the image detecting device 13, the distance between the start position “d” at which the sheet P is sandwiched between each pair of near side and far side second conveying belts 32a and 32b and the focus position b₀ is referred to as “second distance X_{f2}”. Note that the conveyance reference plane A is, for example, a plane that contains the focus position b₀ of the image detecting device 13 and that is orthogonal to an optical axis R of the image detecting device 13.

The first conveying structure 11 and the second conveying structure 12 as well as the image detecting device 13 are set such that formulae (3) to (5) below are satisfied with respect to the first entry angle θ1 and the second entry angle θ2.

$$\begin{matrix}Formula 3 & \\ {θ}_{1} ≦ {tan}^{- 1} ( \frac{Yg}{{X}_{f 1}} ) & ( 3 ) \\ Formula 4 & \\ {θ}_{2} ≦ {tan}^{- 1} ( \frac{Yg}{{X}_{f 2}} ) & ( 4 ) \\ Formula 5 & \\ {θ}_{1} ≦ {cos}^{- 1} \frac{{X}_{f 1} + {X}_{f 2}}{\sqrt{{X}_{f 1}^{2} + {Yg}^{2}} + \sqrt{{X}_{f 2}^{2} + {Yg}^{2}}} & ( 5 )\end{matrix}$$

(Operation of Sheet Discriminating Device According to First Embodiment)

The sheet discriminating device 10 of the first embodiment has the above-described configuration, and the following is a description of the operation of this sheet discriminating device 10. Note that in the following description, a plurality of sheets P, which are to be conveyed, are conveyed one by one at appropriate intermittent timings, for example, in predetermined cycles.

First, in the first conveying structure 11, the pair of near side and far side first conveying belts 22a and 22b that are wound around the first clamp roller 23 of each of the two first conveying portions 24 sandwich a leading end of a sheet P from both sides in the thickness direction. The pair of near side and far side first conveying belts 22a and 22b are driven due to rotation of the first clamp roller 23, thereby applying a conveying force in the conveying direction Da to the sheet P. Thus, the sheet P is conveyed in the conveying direction Da in a state in which the sheet P is sandwiched between the pair of near side and far side first conveying belts 22a and 22b from both sides in the thickness direction.

Then, in the first conveying structure 11, when the leading end of the sheet P reaches the terminal position “a”, the sheet P is sent in the first entry direction D1 from the first conveying structure 11 into the non-retaining region Z by driving of the pair of near side and far side first conveying belts 22a and 22b due to rotation of the corresponding pair of near side and far side first conveying rollers 21a and 21b. Thus, the leading end of the sheet P entering the non-retaining region Z is put in a non-retained state and becomes a free end, and is conveyed in the first entry direction D1 in the shape and position that depend on the rigidity of the sheet P itself and the like.

Then, the image detecting device 13 starts detection when the leading end of the sheet P reaches a passage position (e.g., position at which the sheet P that is conveyed in the first entry direction D1 in a state in which the sheet P maintains a planar shape due to its own rigidity and the like intersects the optical axis R of the image detecting device 13) b₁ on the optical axis R. The image detecting device 13 detects transmitted light using the photo receiver 42, the transmitted light being obtained by the sheet P transmitting light emitted from the light emitter 41 toward the focus position b₀, thereby detecting a transmitted image of the entire surface of the sheet P. Note that as shown in, for example, FIG. 3, the distance b₁b₀ between the passage position b₁ and the focus position b₀ is expressed as shown in a formula (6) below using the first distance X_{f1} and the first entry angle θ₁. In the image detecting device 13, the conveyance position accuracy Yg that is required in order to discriminate the sheet P is set, and therefore the distance b₁b₀ is expressed so as to satisfy a formula (7) below. The formulae (6) and (7) below are expressed as shown in the formula (3) above.

Formula 6

b₁b₀≦X_{f1}× tan θ₁ (6)

Formula 7

b₁b₀≦Yg (7)

Then, when the leading end of the sheet P passes the passage position b₁ and reaches a position “c” on the surface of the far side second conveying belt 32b that is put around the corresponding far side second conveying roller 31b, the far side second conveying belt 32b moves the leading end of the sheet P toward the start position “d” along the outer circumference of the far side second conveying roller 31b. Note that the length “acd” of the travelling path of the leading end of the sheet P when travelling from the terminal position “a” to the start position “d” via the passage position b₁ and the position “c” is approximated to the length “ace” of a straight line extending from the terminal position “a” to an imaginary intersection point position “e” via the passage position b₁ and the position “c”, if the first entry angle θ₁ is small. The imaginary intersection point position “e” is an intersection point in the case where a straight line L that contains the start position “d” and is orthogonal to the conveyance reference plane A and the sheet P (e.g., sheet P1 shown in FIG. 3) that is conveyed in the first entry direction D1 in the state in which the planar shape is maintained due to its own rigidity virtually intersect each other. The length “ace” of this straight line is expressed as shown in a formula (8) below.

$$\begin{matrix}Formula 8 & \\ acd \approx ace = \frac{{X}_{f 1} + {X}_{f 2}}{cos {θ}_{1}} & ( 8 )\end{matrix}$$

(The symbol between the terms “acd” and “ace” is identical in meaning to the symbol “≈”, meaning “approximately equal to.”)

Then, in the second conveying structure 12, when the leading end of the sheet P reaches the start position “d”, each pair of near side and far side second conveying belts 32a and 32b sandwich the leading end of the sheet P from both sides in the thickness direction. The sheet P is sent in the second entry direction D2 from the non-retaining region Z to a space between the pair of near side and far side second conveying rollers 31a and 31b by driving of the pair of near side and far side second conveying belts 32a and 32b due to rotation of the corresponding pair of near side and far side second conveying rollers 31a and 31b. Thus, the sheet P is sandwiched between each pair of near side and far side first conveying belts 22a and 22b at the rear end side and sandwiched between each pair of near side and far side second conveying belts 32a and 32b at the leading end side. The sheet P (e.g., sheet P2 shown in FIG. 3) in this state has a predetermined stable shape in the non-retaining region Z, the shape depending on the terminal position “a” and the start position “d” as well as a predetermined position b₂ on the optical axis R of the image detecting device 13, the predetermined position b₂ depending on the first and second entry angles θ1 and θ2. Note that if the predetermined stable shape is approximated to a triangle, the length “ab₂d” of the sheet P from the terminal position “a” to the start position “d” via the predetermined position b₂ is expressed as shown in a formula (9) below with respect to the distance b₂b₀ between the predetermined position b₂ and the focus position b₀.

Formula 9

ab₂d=\sqrt{X_{f1}²+b₂b₀²}+\sqrt{X_{f2}²+b₂b₀²} (9)

Also, the conveyance speed at which the pairs of near side and far side first conveying belts 22a and 22b convey the rear end side of the sheet P and the conveyance speed at which the pairs of near side and far side second conveying belts 32a and 32b convey the leading end side of the sheet P are equal to each other. Thus, the length of the sheet P in the non-retaining region Z, the sheet P being sandwiched between each pair of near side and far side first conveying belts 22a and 22b at the rear end side and sandwiched between each pair of near side and far side second conveying belts 32a and 32b at the leading end side, is fixed. That is to say, the length “acd” in the formula (8) above and the length “ab₂d” in the formula (9) above are expressed so as to satisfy a formula (10) below. Furthermore, in the image detecting device 13, the conveyance position accuracy Yg that is required in order to discriminate the sheet P is set, and therefore the distance b₂b₀ is expressed so as to satisfy a formula (11) below. The formulae (10) and (11) are expressed as shown in the formula (5) above.

Formula 10

acd=ab₂d (10)

Formula 11

b₂b₀≦Yg (11)

Note that if the optical axis R of the image detecting device 13 is located at the center between the terminal position “a” and the start position “d”, X_{f1}=X_{F2}=X_{f}/2 is satisfied, where X_{f} represents the distance between the terminal position “a” and the start position “d”, and therefore the formula (5) above is expressed as shown in a formula (12) below.

$$\begin{matrix}Formula 12 & \\ {θ}_{1} ≦ {cos}^{- 1} \frac{1}{\sqrt{1 + {( 2 \times \frac{Yg}{{X}_{f}} )}^{2}}} & ( 12 )\end{matrix}$$

Then, in the second conveying structure 12, when the leading end of the sheet P reaches the second clamp rollers 33 of the two respective second conveying portions 34, a conveying force in the conveying direction Da is applied to the leading end of the sheet P by driving of the pairs of near side and far side second conveying belts 32a and 32b that are wound around the respective second clamp rollers 33. Thus, the sheet P is conveyed in the conveying direction Da by the conveying forces that are applied from the first and second clamp rollers 23 and 33 in a state in which the rear end side of the sheet P is sandwiched between each pair of near side and far side first conveying belts 22a and 22b and the leading end side is sandwiched between each pair of near side and far side second conveying belts 32a and 32b.

Then, when the rear end of the sheet P passes the first clamp rollers 23, the sheet P is conveyed in the conveying direction Da by the conveying force that is applied from the second clamp rollers 33. Then, when the rear end of the sheet P passes the terminal position “a” and enters the non-retaining region Z from the first conveying structure 11, the rear end of the sheet P is put in a non-retained state and becomes a free end, and is sent into the non-retaining region Z in a shape and a position that are restrained from deforming due to the rigidity of the sheet P itself, the air resistance, and the like. Then, the image detecting device 13 continues detection until, as shown in, for example, FIG. 4, the rear end of the sheet P passes the passage position (e.g., position at which the sheet P that is conveyed in the second entry direction D2 in a state in which the planar shape is maintained due to its own rigidity intersects the optical axis R of the image detecting device 13) b₃ on the optical axis R. Note that as shown in FIG. 4, a distance b₃b₀ between the passage position b₃ and the focus position b₀ is expressed as shown in a formula (13) below using the second distance X_{f2} and the second entry angle θ2. In the image detecting device 13, the conveyance position accuracy Yg that is required in order to discriminate the sheet P is set, and therefore the distance b₃b₀ is expressed so as to satisfy a formula (14) below. The formulae (13) and (14) below are expressed as shown in the formula (4) above.

Formula 13

b₃b₀≦X_{f2}× tan θ₂ (13)

Formula 14

b₃b₀≦Yg (14)

Then, when the rear end of the sheet P enters the second conveying structure 12 from the non-retaining region Z and furthermore reaches the second clamp rollers 33, the second conveying structure 12 sends the rear end of the sheet P from the second conveying structure 12 to the outside. Thus, conveyance of a single sheet P is ended.

As described above, with the sheet discriminating device 10 according to the first embodiment, it is possible to detect the optical information on the entire surface of a sheet P using the image detecting device 13 while suppressing the occurrence of a conveyance failure of the sheet P simply by keeping the first and second conveying structures 11 and 12 and the image detecting device 13 in an appropriate arrangement, and to appropriately discriminate the sheet P in accordance with the detection results. Furthermore, with the sheet processing apparatus 110 according to the first embodiment, since the sheet discriminating device 10 according to the first embodiment is provided, it is possible to appropriately process the sheet P in accordance with the accurate discrimination results with respect to the sheet P.

### First Modification

Note that in the first embodiment described above, like a first modification as shown in, for example, FIGS. 5 and 6, it is also possible that at least one, for example, four pairs of first to fourth guide members 51, . . . , 54 are provided without interrupting the optical axis R of the image detecting device 13 in the non-retaining region Z. The first to fourth guide members 51, . . . , 54 are each a fixed guide member that is formed of a metal such as, for example, stainless steel, which has wear resistance and corrosion resistance, or an aluminum alloy subjected to a surface hardening treatment into a plate shape. The pair of first guide members 51 and the pair of second guide members 52 are arranged in respective positions to the outside of the two first conveying portions 24 in the axial direction Db, the guide members of each pair opposing each other in the orthogonal direction Dc with a predetermined distance interposed therebetween so as to sandwich the conveyance reference plane A from both sides. The pair of third guide members 53 and the pair of fourth guide members 54 are arranged in respective positions to the outside of the two second conveying portions 34 in the axial direction Db, the guide members of each pair opposing each other in the orthogonal direction Dc with a predetermined distance interposed therebetween so as to sandwich the conveyance reference plane A from both sides. According to this first modification, even if the sheet P has a crease or a bend or the sheet P has low rigidity, the occurrence of a conveyance failure such as a jam or slipping-off can be prevented.

### Second Modification

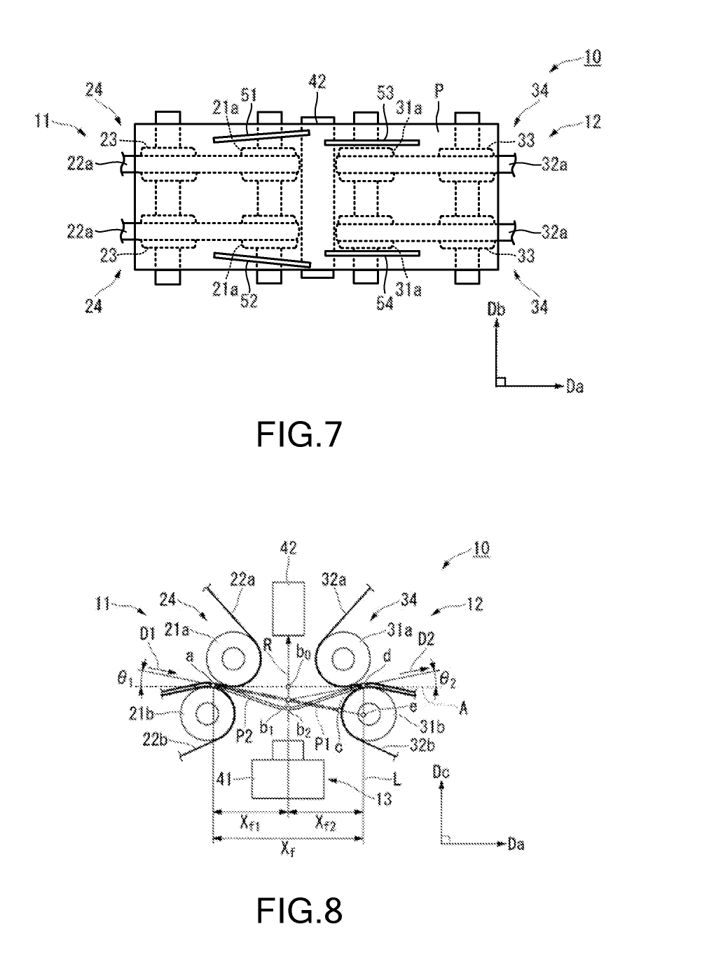

Note that in the first modification according to the first embodiment described above, like a second modification shown in, for example, FIG. 7, it is also possible that the first guide members 51 are arranged obliquely to the conveying direction Da. Moreover, it is also possible that the second guide members 52 each have a shape that is bent or curved with respect to the conveying direction D1. According to this second modification, the first and second guide members 51 and 52 having shapes that are suitable for surrounding structures and the like can be arranged in appropriate positions, and the occurrence of a failure with respect to conveyance of the sheet P can be appropriately suppressed.

### Third Modification

Note that in the first embodiment described above, like a third modification shown in, for example, FIG. 8, it is also possible that the first and second clamp rollers 23 and 33 are omitted. In this case, each near side first conveying belt 22a is turned back in a direction away from the second conveying structure 12 by the corresponding near side first conveying roller 21a and then wound around the corresponding far side first conveying roller 21b along with the corresponding far side first conveying belt 22b. Also, each near side second conveying belt 32a is turned back in a direction away from the first conveying structure 11 by the corresponding near side second conveying roller 31a and then wound around the corresponding far side second conveying roller 31b along with the corresponding far side second conveying belt 32b. The near side and far side first conveying belts 22a and 22b that are wound around the far side first conveying roller 21b sandwich the sheet P from both sides in the thickness direction, and can apply a conveying force in the first entry direction D1 to the sheet P entering the non-retaining region Z from the terminal position “a”. The near side and far side second conveying belts 32a and 32b that are wound around the far side second conveying roller 31b sandwich the sheet P from both sides in the thickness direction, and can apply a conveying force in the second entry direction D2 to the sheet P advancing to the start position “d” from the non-retaining region Z. According to this third modification, it is possible to simplify the device configuration and reduce the device size when compared with the case where the first and second clamp rollers 23 and 33 are provided.

Note that the first embodiment described above has been presented by way of example only, and is not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the first embodiment described above, it is also possible that the first entry angle θ1 and the second entry angle θ2 are set at zero, so that the first entry direction D1 and the second entry direction D2 are parallel to the conveying direction Da. In this case, the conveyance position stability of the sheet P can be improved while suppressing the occurrence of a conveyance failure.

For example, in the first embodiment described above, it is also possible that the image detecting device 13 includes a photo receiver that detects reflected light obtained by the sheet P reflecting light emitted from the light emitter 41, instead of the photo receiver 42 that detects transmitted light. Also, for example, instead of the image detecting device 13, another proximity sensor may be provided that detects magnetism, an induced current, capacitance, ultrasonic waves, photoelectricity, or the like.

(Configuration of Second Embodiment of Sheet Discriminating Device)

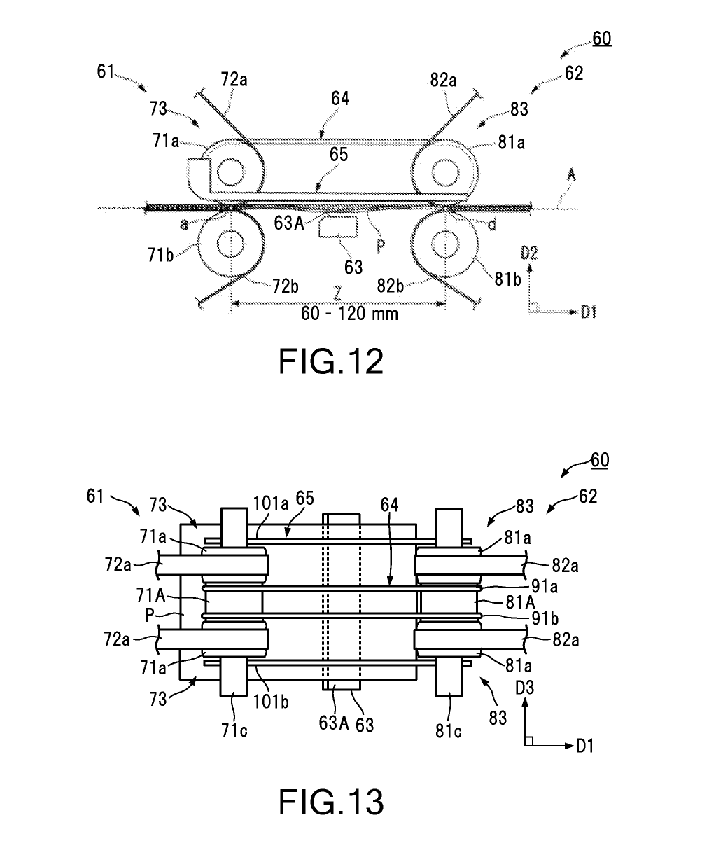

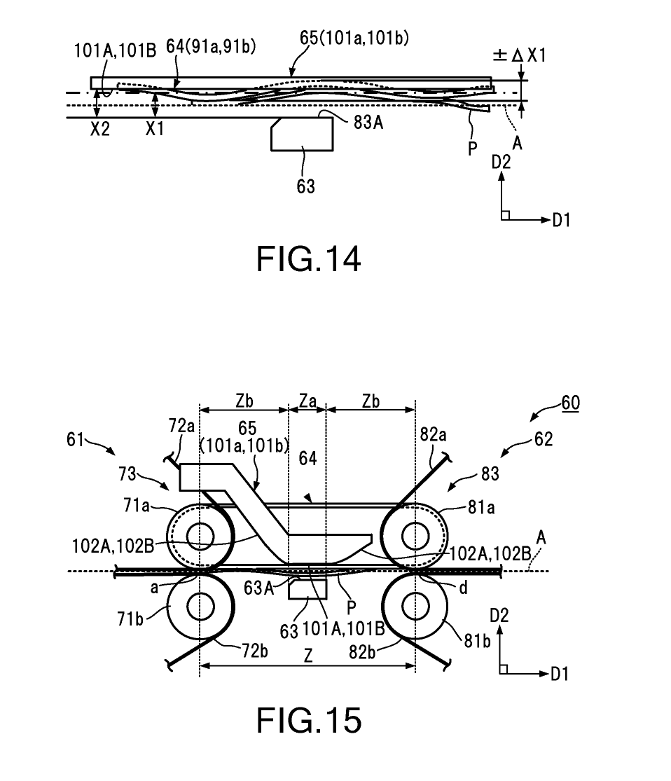

Hereinafter, a sheet discriminating device 60 that is included in the sheet processing apparatus 110 will be described in detail. FIGS. 12 and 13 schematically show the configuration of the sheet discriminating device 60, and FIG. 14 is an enlarged view showing a portion of the sheet discriminating device 60 in an enlarged manner. The sheet discriminating device 60 according to the second embodiment constitutes at least a portion of the magnetic detecting device 116A of the inspection portion 116 of the sheet processing apparatus 110 described above, and includes, as shown in FIGS. 12 and 13, a first conveying structure 61, a second conveying structure 62, a magnetic sensor 63, a first guide member 64, and a second guide member 65.

The first conveying structure 61 and the second conveying structure 62 are arranged with a distance that is shorter than the length of the sheet P to be conveyed interposed therebetween in the conveying direction D1 that is parallel to the conveyance reference plane A that is set between the first conveying structure 61 and the second conveying structure 62.

The first conveying structure 61 employs a combination of a pair of first conveying rollers 71a and 71b, and a pair of first conveying belts 72a and 72b that are respectively put around the pair of first conveying rollers 71a and 71b and turned back in a direction away from the second conveying structure 62 as a single first conveying portion 73, and includes a plurality of, for example, two first conveying portions 73. The two first conveying portions 73 are arranged at a predetermined distance from each other in a direction (i.e., axial direction D3 that extends along the width of the sheet P and is parallel to the axes of rotation of the pair of first conveying rollers 71a and 71b) that is parallel to the conveyance reference plane A and orthogonal to the conveying direction D1.

Each pair of first conveying rollers 71a and 71b is arranged such that the respective axes of rotation are parallel to the axial direction D3 and at a predetermined distance from each other in the orthogonal direction D2 that is orthogonal to the conveyance reference plane A, thereby being arranged opposing each other in the orthogonal direction D2. Each pair of first conveying belts 72a and 72b is driven by a motor (not shown) or the like in a state in which these first conveying belts sandwich the sheet P from both sides in the thickness direction between the corresponding pair of first conveying rollers 71a and 71b, thereby applying a conveying force in the conveying direction D1 that is parallel to the direction from the first conveying structure 61 toward the second conveying structure 62 to the sheet P.

The second conveying structure 62 employs a combination of a pair of second conveying rollers 81a and 81b and a pair of second conveying belts 82a and 82b that are respectively put around the pair of second conveying rollers 81a and 81b and turned back in a direction away from the first conveying structure 61 as a single second conveying portion 83, and includes a plurality of, for example, two second conveying portions 83. The two second conveying portions 83 are arranged at a predetermined distance from each other in the direction (i.e., axial direction D3 that extends along the width of the sheet P and is parallel to the axes of rotation of the pair of second conveying rollers 81a and 81b) that is parallel to the conveyance reference plane A and orthogonal to the conveying direction D1. Each pair of second conveying rollers 81a and 81b is arranged such that the respective axes of rotation are parallel to the axial direction D3 and at a predetermined distance from each other in the orthogonal direction D2 that is orthogonal to the conveyance reference plane A, thereby being arranged opposing each other in the orthogonal direction D2. Each pair of second conveying belts 82a and 82b is driven by a motor (not shown) or the like in a state in these second conveying belts sandwich the sheet P from both sides in the thickness direction between the corresponding pair of second conveying rollers 81a and 81b, thereby applying a conveying force in the conveying direction D1 to the sheet P.

In the first conveying structure 61 and the second conveying structure 62, the peripheral speeds of the pairs of first conveying belts 72a and 72b and the pairs of second conveying belts 82a and 82b in association with rotation of the pairs of first conveying rollers 71a and 71b and the pairs of second conveying rollers 81a and 81b are set to be uniform. In the first conveying structure 61 and the second conveying structure 62, the region between the terminal position “a” at which the sheet P is sandwiched between each pair of first conveying belts 72a and 72b and the start position “d” at which the sheet P is sandwiched between each pair of second conveying belts 82a and 82b is set as the non-retaining region Z in which the sheet P is not retained. Also, the position and shape of the sheet P in this non-retaining region Z are maintained by the rigidity of the sheet P itself, the air resistance, and the like. In the first conveying structure 61 and the second conveying structure 62, the length of the non-retaining region Z in the conveying direction D1 is set to be shorter than the length of the sheet P. The length of the non-retaining region Z in the conveying direction D1 is set at preferably 60 to 120 mm. Thus, at least either of the first conveying structure 61 and the second conveying structure 62 continuously applies the conveying force to the sheet P that is being conveyed.

The magnetic sensor 63 is arranged such that a detecting surface 63A is oriented in the direction toward the surface of the sheet P that is conveyed into the non-retaining region Z (i.e., orthogonal direction D2 that is orthogonal to the conveyance reference plane A), and detects magnetic feature information (magnetic information) on the sheet P that passes the vicinity of the detecting surface 63A. The detecting surface 63A of the magnetic sensor 63 is, for example, formed to be larger than the width of the sheet P in the axial direction D3 (i.e., width direction of the sheet P). The distance from the detecting surface 63A to a predetermined detection limit position in the orthogonal direction D2 is set as “detection limit gap amount XG” of the magnetic sensor 63. Note that the conveyance reference plane A is, for example, a plane that contains a predetermined detection reference point that is set on a detection axis of the magnetic sensor 63 extending parallel to the orthogonal direction D2 from the detecting surface 63A of the magnetic sensor 63 and that is orthogonal to the detection axis.

The first guide member 64 is a movable guide configured by, for example, a round belt having a circular cross-sectional shape. The first guide member 64 is composed of at least one, for example, two round belts 91a and 91b, and extends between a first pulley portion 71A of the first conveying rollers 71a and a second pulley portion 81A of the second conveying rollers 81a, the first and second pulley portions 71A and 81A being arranged on an opposite side of the conveyance reference plane A from the magnetic sensor 63, of the pairs of first conveying rollers 71a and 71b and the pairs of second conveying rollers 81a and 81b. Note that the first pulley portion 71A is provided between the first conveying rollers 71a of the two respective first conveying portions 73, which are arranged at a predetermined distance from each other in the axial direction D3, integrally with a rotary shaft 71c that is shared by the first conveying rollers 71a. The second pulley portion 81A is provided between the second conveying rollers 81a of the two respective second conveying portions 83, which are arranged at a predetermined distance from each other in the axial direction D3, integrally with a rotary shaft 81c that is shared by the second conveying rollers 81a.

The two round belts 91a and 91b of the first guide member 64 are arranged at a predetermined distance from each other in the axial direction (i.e., width direction of the sheet P) D3, oppose the magnetic sensor 63 in the orthogonal direction D2 in the non-retaining region Z, and are arranged such that the sheet P can be inserted between the magnetic sensor 63 and these round belts. The two round belts 91a and 91b of the first guide member 64 apply a conveying force in the conveying direction D1 to the sheet P as the first pulley portion 71A and the second pulley portion 81A rotate. Note that the first pulley portion 71A and the second pulley portion 81A have such shapes (e.g., outer diameters etc.) that, for example, makes the peripheral speed of the pairs of first conveying belts 72a and 72b and the pairs of second conveying belts 82a and 82b in association with rotation of the pairs of first conveying rollers 71a and 71b and the pairs of second conveying rollers 81a and 81b and the peripheral speed of the round belts 91a and 91b of the first guide member 64 in association with rotation of the first pulley portion 71A and the second pulley portion 81A equal to each other.

The two round belts 91a and 91b of the first guide member 64 are arranged such that the distance from the magnetic sensor 63 when oscillating with maximum amplitude in the orthogonal direction D2 in which those round belts oppose the magnetic sensor 63 is greater than zero. As shown in FIG. 14, when the maximum amplitude of the oscillation of the two round belts 91a and 91b during operation of the sheet processing apparatus 110 is represented by +ΔX1, the two round belts 91a and 91b that are each arranged on the opposite side of the conveyance reference plane A from the detecting surface 63A of the magnetic sensor 63 and spaced apart from the conveyance reference plane A by a distance X1 at an attachment reference time are set so as to satisfy a formula (1) below.

Formula 1

X1>ΔX1 (1)

Also, as shown in FIG. 13, the two round belts 91a and 91b of the first guide member 64 are provided such that when seen in the axial direction D3, those round belts overlap the pairs of first conveying belts 72a and 72b and the pairs of second conveying belts 82a and 82b of the two first conveying portions 73 and the two second conveying portions 83, respectively, in the conveying direction D1. Thus, the two round belts 91a and 91b of the first guide member 64 can come into contact with the sheet P over the entire non-retaining region Z.

The second guide member 65 is a fixed guide member that is formed of, for example, a nonmagnetic or weakly magnetic metal or the like into a plate shape. Examples of the nonmagnetic metal include an Al alloy, a Ti alloy, stainless steel, and the like. The second guide member 65 is configured by at least one, for example, two plate-like members 101a and 101b, opposes at least the detecting surface 63A of the magnetic sensor 63 in the non-retaining region Z, and is arranged such that the sheet P can be inserted between the magnetic sensor 63 and the second guide member 65. Also, the two plate-like members 101a and 101b of the second guide member 65 are arranged so as to, for example, sandwich the two first conveying portions 73 and the two second conveying portions 83 from both sides in the axial direction D3. The two plate-like members 101a and 101b of the second guide member 65 are arranged so as to be nearer to the magnetic sensor 63 in the direction (i.e., orthogonal direction D2) in which those plate-like members oppose the magnetic sensor 63 than the detection limit position of the magnetic sensor 63 is and also farther from the magnetic sensor 63 in the orthogonal direction D2 than the first guide member 64 is, and restrict the position of the sheet P in the orthogonal direction D2. As shown in FIG. 14, the two plate-like members 101a and 101b of the second guide member 65 include facing surfaces 101A and 101B that each face the detecting surface 63A of the magnetic sensor 63 across the conveyance reference plane A in the orthogonal direction D2. The distance X2 of these facing surfaces 101A and 101B from the detecting surface 63A of the magnetic sensor 63 is set so as to satisfy a formula (2) below with respect to the detection limit gap amount XG of the magnetic sensor 63. Furthermore, the distance X2 is set so as to satisfy a formula (3) below with respect to the distance X1 of the first guide member 64 at the attachment reference time.

Formula 2

X2≧XG (2)

Formula 3

X1<X2 (3)

Also, as shown in FIG. 13, the two plate-like members 101a and 101b of the second guide member 65 are provided such that when seen in the axial direction D3, these plate-like members overlap the pairs of first conveying belts 72a and 72b and the pairs of second conveying belts 82a and 82b of the two first conveying portions 73 and the two second conveying portions 73, respectively, in the conveying direction D1. Thus, the two plate-like members 101a and 101b of the second guide member 65 can restrict the position of the sheet P in the orthogonal direction D2 over the entire non-retaining region Z.

(Operation of Sheet Discriminating Device According to Second Embodiment)

The sheet discriminating device 60 of the second embodiment has the above-described configuration, and the following is a description of the operation of this sheet discriminating device 60. Note that in the following description, it is assumed that a plurality of sheets P, which are to be conveyed, are conveyed one by one at appropriate intermittent timings, for example, in predetermined cycles.

First, the first conveying structure 61 sandwiches the sheet P from both sides in the thickness direction using the pair of first conveying belts 72a and 72b between the pair of first conveying rollers 71a and 71b of each of the two first conveying portions 73. The pairs of first conveying belts 72a and 72b are driven due to rotation of the respective pairs of first conveying rollers 71a and 71b, thereby sending the sheet P in the conveying direction D1 from the first conveying structure 61 into the non-retaining region Z between the first conveying structure 61 and the second conveying structure 62. Thus, the leading end of the sheet P that enters the non-retaining region Z is put in a non-retained state and becomes a free end, and is conveyed in the conveying direction D1 in a shape and position that depend on the rigidity of the sheet P itself and the like.

The two round belts 91a and 91b of the first guide member 64 are driven due to rotation of the first pulley portion 71A and the second pulley portion 81A, thereby applying a conveying force in the conveying direction D1 to the sheet P, which is in contact with the round belts 91a and 91b in the non-retaining region Z, due to friction. Also, the two plate-like members 101a and 101b of the second guide member 65 restrict the position of the sheet P in the orthogonal direction D2, the sheet P being in contact with the facing surfaces 101A and 101B of the respective plate-like members 101a and 101b in the non-retaining region Z.

More specifically, if oscillation of the two round belts 91a and 91b of the first guide member 64 in the orthogonal direction D2 is small, and a formula (4) below is satisfied, the position of the sheet P in the orthogonal direction D2 is restricted by the two round belts 91a and 91b while the conveying force can be applied to the sheet P by the two round belts 91a and 91b. Thus, the sheet P is restricted such that the distance from at least the detecting surface 63A of the magnetic sensor 63 in the orthogonal direction D2 is not greater than the detection limit gap amount XG of the magnetic sensor 63. On the other hand, if oscillation of the two round belts 91a and 91b of the first guide member 64 in the orthogonal direction D2 is large, and a formula (5) below is satisfied, the position of the sheet P in the orthogonal direction D2 is restricted by the two plate-like members 101a and 101b of the second guide member 65 while the conveying force can be intermittently applied to the sheet P by the two round belts 91a and 91b. Thus, the sheet P is restricted such that the distance from at least the detecting surface 63A of the magnetic sensor 63 in the orthogonal direction D2 is not greater than the detection limit gap amount XG of the magnetic sensor 63.

Formula 4

X1+ΔX1≦X2(≦XG) (4)

Formula 5

X1+ΔX1>X2 (5)

Also, the magnetic sensor 63 starts detection when the leading end of the sheet P reaches within a predetermined detection range, and detects the magnetic information from the sheet P. Then, when the leading end of the sheet P enters the second conveying structure 62 from the non-retaining region Z, the second conveying structure 62 sandwiches the sheet P from both sides in the thickness direction using the pair of second conveying belts 82a and 82b between the pair of second conveying rollers 81a and 81b of each of the two second conveying portions 83. The pairs of second conveying belts 82a and 82b are driven due to rotation of the respective pairs of second conveying rollers 81a and 81b, thereby sending the sheet P in the conveying direction D1 from the second conveying structure 62 to the outside. Thus, the sheet P is conveyed in the conveying direction D1 while extending over the entire non-retaining region Z in a state in which the rear end side is sandwiched between each pair of first conveying belts 72a and 72b, and the leading end side is sandwiched between each pair of second conveying belts 82a and 82b.

Then, when the rear end of the sheet P enters the non-retaining region Z from the first conveying structure 61, the rear end of the sheet P is put in a non-retained state and becomes a free end, and is conveyed in the conveying direction D1 in a shape and position that depend on the rigidity of the sheet P itself and the like. Then, when the rear end of the sheet P has passed through the predetermined detection range, the magnetic sensor 63 finishes the detection. Then, when the rear end of the sheet P enters the second conveying structure 62 from the non-retaining region Z, the second conveying structure 62 sends the rear end of the sheet P in the conveying direction D1 from the second conveying structure 62 to the outside. Thus, conveyance of a single sheet P is ended.

As described above, with the sheet discriminating device 60 according to the second embodiment, the first guide member 64 and the second guide member 65 are used in combination, and it is therefore possible to easily retain the sheet P in an appropriate position with respect to the magnetic sensor 63 while applying the conveying force in the conveying direction D1 to the sheet P. Thus, occurrence of a conveyance failure can be suppressed while accurately detecting the magnetic information on the sheet P.

For example, if the conveyance speed of the sheet P is increased, the pairs of first conveying belts 72a and 72b and the pairs of second conveying belts 82a and 82b, the pairs of first conveying rollers 71a and 71b and the pairs of second conveying rollers 81a and 81b, the motor (not shown), and the like are rotated rapidly, and the oscillation of the sheet discriminating device 60 increases accordingly. In this case, even if the oscillation of the two round belts 91a and 91b of the first guide member 64 increases, the position of the sheet P is restricted by the second guide member 65 in accordance with the detection limit gap amount XG of the magnetic sensor 63, and it is therefore possible to improve the processing performance of the sheet discriminating device 60 per unit time while maintaining desired detection capability of the magnetic sensor 63. Also, for example, in the case where the sheet P has a high rigidity, even if the impact of a collision with the sheet P causes the two round belts 91a and 91b of the first guide member 64 to oscillate largely, the position of the sheet P is restricted by the second guide member 65.

Furthermore, the combination of the round belts 91a and 91b of the first guide member 64 and the plate-like members 101a and 101b of the second guide member 65 makes it possible to reduce the cost of the device configuration when compared with the case where, for example, a platen roller or the like is used, and also to reduce the device size. Furthermore, the round belts 91a and 91b of the first guide member 64 can be formed to have a smaller surface area than, for example, a platen roller or the like, so that magnetic powder that is produced due to abrasion of other surrounding structures is unlikely to adhere to those round belts, and it is thus possible to suppress a decrease in detection capability of the magnetic sensor 63. Furthermore, the combination of the round belts 91a and 91b of the first guide member 64 and the plate-like members 101a and 101b of the second guide member 65 makes it possible to suppress shielding of the conveying path from view as compared with a case where, for example, a platen roller or the like is used, and it is thus possible to facilitate the maintenance work.

Furthermore, the provision of the sheet discriminating device 60 according to the second embodiment makes it possible for the sheet processing apparatus 110 to appropriately process the sheet P in accordance with accurate discrimination results with respect to the sheet P.

### First Modification

Note that in the above-described second embodiment, like a first modification shown, for example, in FIG. 15, it is also possible that the second guide member 65 is provided so as to be able to restrict the position of the sheet P only in a first region Za opposing the magnetic sensor 63 of the non-retaining region Z between the first conveying structure 61 and the second conveying structure 62 and so as not to come into contact with the sheet P in a second region Zb other than the first region Za. The two plate-like members 101a and 101b of the second guide member 65 according to this first modification include respective facing surfaces 101A and 101B that face the detecting surface 63A of the magnetic sensor 63 only in the first region Za opposing the magnetic sensor 63. Also, surfaces 102A and 102B that are continuous with the respective facing surfaces 101A and 101B of the two plate-like members 101a and 101b are formed such that the respective distances from the conveyance reference plane A in the orthogonal direction D2 change in an increasing manner as the distance from the first region Za increases toward the first conveying structure 61, or as the distance from the first region Za increases toward the second conveying structure 62, in the non-retaining region Z. According to this first modification, it is possible to reduce the frictional resistance between the sheet P and the second guide member 15 and suppress a decrease in the conveyance speed of the sheet P.

### Second Modification

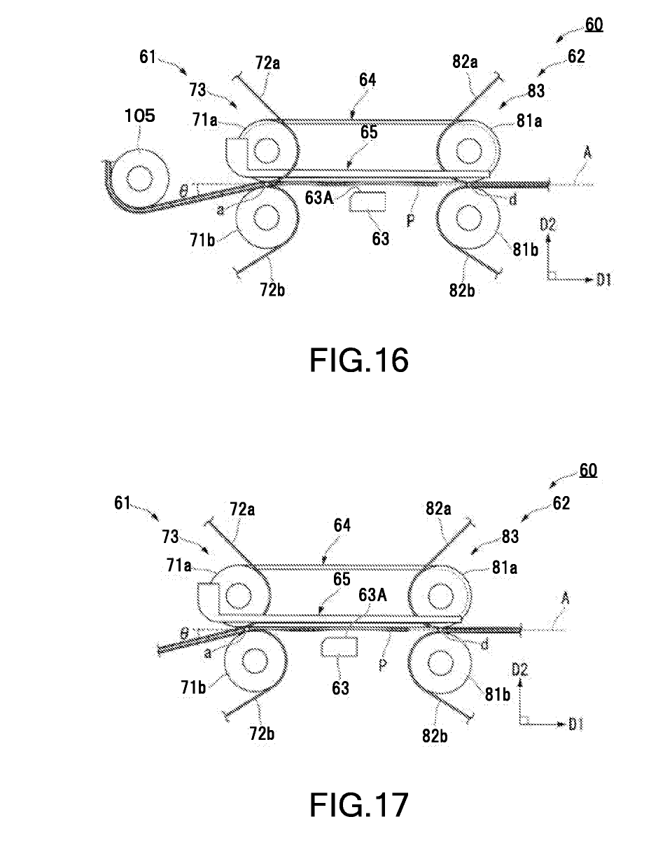

Note that in the above-described second embodiment, like a second modification shown in, for example, FIG. 16 or 17, it is also possible that the first conveying structure 61 is arranged such that the entry angle θ of the sheet P that is directed from an opposite side of the conveyance reference plane A from the first guide member 64 toward the first guide member 64 and advances onto the conveyance reference plane A from the first conveying structure 61 is an acute angle that is greater than zero. For example, in the first conveying structure 61 according to the second modification shown in FIG. 16, each first conveying portion 73 includes, on an upstream side in the conveying direction D1 of the sheet P, a roller 105 around which the pair of first conveying belts 72a and 72b extending from the space between the corresponding pair of first conveying rollers 71a and 71b are wound. This roller 105 is arranged on the opposite side of the conveyance reference plane A from the first guide member 64, and thus inclines the pair of first conveying belts 72a and 72b with respect to the conveyance reference plane A by the entry angle θ.

Also, in the first conveying structure 61 according to the second modification shown in, for example, FIG. 17, each first conveying portion 73 includes a pair of first conveying rollers 71a and 71b that are arranged offset from each other in a direction that is parallel to the conveyance reference plane A. The first conveying roller 71a of the pair of first conveying rollers 71a and 71b that is arranged on the opposite side of the conveyance reference plane A from the magnetic sensor 63 is spaced apart from the second conveying structure 62 by a larger distance than the first conveying roller 71b, and thus the pair of first conveying belts 72a and 72b are inclined with respect to the conveyance reference plane A by the entry angle θ. According to the second modification described above, when the sheet P entering the non-retaining region Z with the entry angle θ comes into contact with the round belts 91a and 91b of the first guide member 64, the round belts 91a and 91b more easily apply the conveying force in the conveying direction D1 to the sheet P due to friction.

### Third Modification

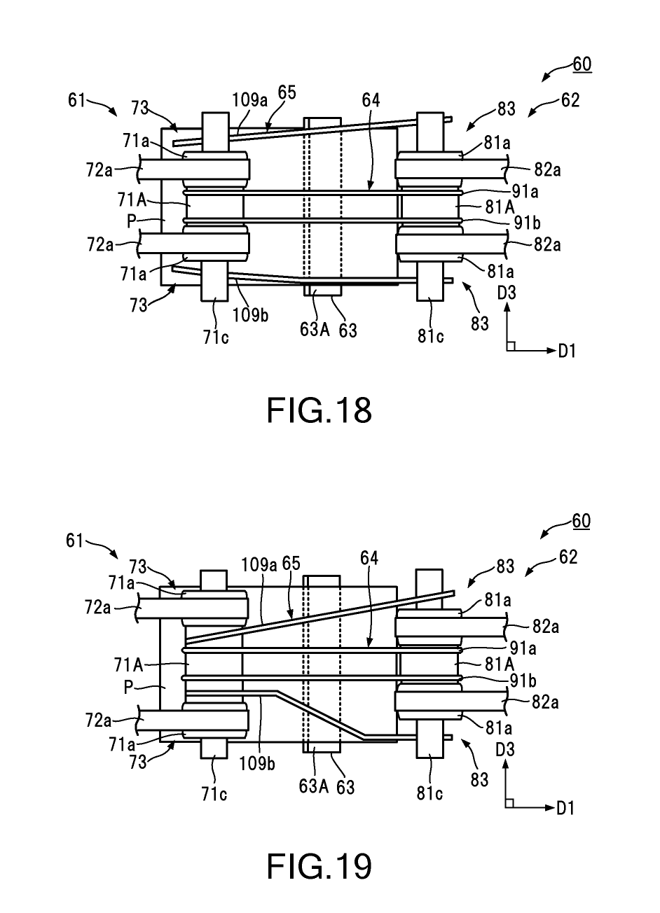

Note that in the above-described second embodiment, like a third modification shown in, for example, FIG. 18 or 19, it is also possible that the second guide member 65 includes a plate-like member 109a that is arranged obliquely to the conveying direction D1. Moreover, it is also possible that the second guide member 65 includes a plate-like member 109b that is bent or curved with respect to the conveying direction D1. The second guide member 65 according to the third modification shown in, for example, FIG. 18 includes a pair of plate-like members 109a and 109b that sandwich the two first conveying portions 73 and the two second conveying portions 83 from both sides in the axial direction D3. The plate-like member 109a is arranged, for example, so as to be located closer to the corresponding first conveying portion 73 in the axial direction D3 and located further away from the corresponding second conveying portion 83 in the axial direction D3, and is thus arranged obliquely to the conveying direction D1. The plate-like member 109b is arranged, for example, so as to be curved toward a position that is closer to the corresponding first conveying portion 73 in the axial direction D3 and located further away from the corresponding second conveying portion 83 in the axial direction D3.

Also, the second guide member 65 of the third modification shown in, for example, FIG. 19 includes a pair of plate-like members 109a and 109b and is arranged in accordance with the arrangement of the two first conveying portions 73 and the two second conveying portions 83, the first conveying portions 73 being arranged at a distance from each other in the axial direction D3, and the second conveying portions 83 being arranged at a distance different from that of the two first conveying portions 73 from each other. The plate-like members 109a and 109b are, for example, arranged such that with respect to the two first conveying portions 73, these plate-like members are arranged between the two first conveying portions 73, whereas with respect to the two second conveying portions 83, these plate-like members sandwich the two second conveying portions 83 from both sides in the axial direction D3. Moreover, the plate-like member 109a is arranged obliquely to the conveying direction D1, and the plate-like member 109b is bent with respect to the conveying direction D1. According to the third modification described above, the second guide member 65 that is shaped so as to be suitable for surrounding structures and the like can be arranged in an appropriate position, and therefore occurrence of a failure with respect to conveyance of the sheet P can be suppressed appropriately.

### Fourth Variation

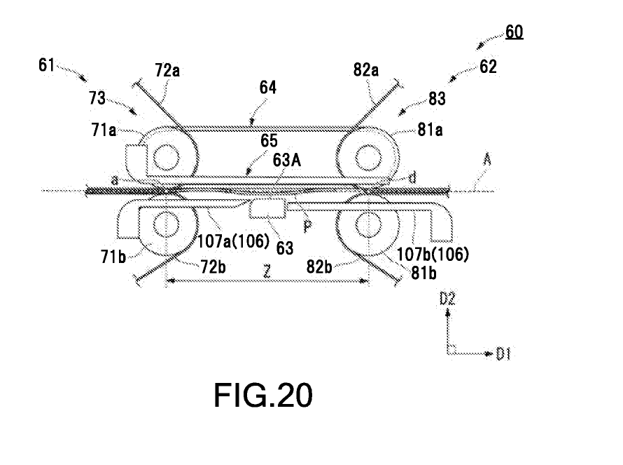

Note that in the above-described second embodiment, like a fourth variation shown in, for example, FIG. 20, it is also possible that a third guide member 106 is provided on the opposite side of the conveyance reference plane A, which is set between the first conveying structure 61 and the second conveying structure 62, from the second guide member 65. The third guide member 106 is arranged such that the distance from the conveyance reference plane A is greater than the distance between the conveyance reference plane A and the magnetic sensor 63, and restricts the position of the sheet P in the orthogonal direction D2. The third guide member 106 is, for example, a fixed guide member that is formed of a nonmagnetic or weakly magnetic metal or the like into a plate shape. The third guide member 106 includes at least one, for example, two plate-like members 107a and 107b. With regard to the plate-like member 107a that is arranged between the first conveying structure 61 and the magnetic sensor 63 (i.e., upstream of the magnetic sensor 63) in the conveying direction D1, for example, the distance from the conveyance reference plane A is set to be equal to the distance between the conveyance reference plane A and the detecting surface 63A of the magnetic sensor 63. With regard to the plate-like member 107b that is arranged between the magnetic sensor 63 and the second conveying structure 62 (i.e., downstream of the magnetic sensor 63) in the conveying direction D1, for example, the distance from the conveyance reference plane A is set to be greater than the distance between the conveyance reference plane A and the detecting surface 63A of the magnetic sensor 63. According to this fourth variation, even if, for example, the sheet P is bent toward the detecting surface 63A of the magnetic sensor 63, or the sheet P has low rigidity, occurrence of a conveyance failure can be suppressed.

Note that the second embodiment described above has been presented by way of example only, and is not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above-described second embodiment, the positions of the first guide member 64 and the second guide member 65 in the axial direction D3 can be set as appropriate. For example, with respect to the first conveying rollers 71a and the second conveying rollers 81a, the first guide member 64 and the second guide member 65 may also be arranged between the first conveying rollers 71a and also between the second conveying rollers 81a. Moreover, it is also possible that the first guide member 64 is arranged to the outside of the first conveying rollers 71a and the second conveying rollers 81a in the axial direction D3, and the second guide member 65 is arranged between the first conveying rollers 71a and also between the second conveying rollers 81a.

For example, in the above-described second embodiment, the first guide member 64 is not limited to the two round belts 91a and 91b, and may include one or three or more round belts. Also, the second guide member 65 is not limited to the two plate-like members 101a and 101b, and may include one or three or more plate-like members. Moreover, the number of round belts included in the first guide member 64 and the number of plate-like members included in the second guide member 65 may be different from each other.

For example, in the above-described second embodiment, the first guide member 64 may also be driven by another actuator, for example, a dedicated motor or the like other than the first conveying structure 61 and the second conveying structure 62.

For example, in the above-described second embodiment, the first guide member 64 may include a flat belt instead of a round belt.

For example, in the above-described second embodiment, instead of the magnetic sensor 63, another proximity sensor that detects an induced current, capacitance, ultrasonic waves, photoelectricity, or the like may be provided.

For example, in the above-described second embodiment, in the first conveying structure 61 and the second conveying structure 62, the pairs of first conveying belts 72a and 72b and the pairs of second conveying belts 82a and 82b may be flat belts or round belts. Also, in the first conveying structure 61 and the second conveying structure 62, the pairs of first conveying belts 72a and 72b and the pairs of second conveying belts 82a and 82b may be omitted, and in this case, it is sufficient if a conveying force is applied to the sheet P in a state in which the sheet P is sandwiched by the pairs of first conveying rollers 71a and 71b and the pairs of second conveying rollers 81a and 81b from both sides in the thickness direction.

For example, in the above-described second embodiment, the peripheral speed of the round belts 91a and 91b of the first guide member 64 may be different from the peripheral speed of the first conveying belts 72a and 72b and the second conveying belts 82a and 82b to an extent that does not impair the conveying function. For example, the peripheral speed of the round belts 91a and 91b may be 5% faster than or slower than the peripheral speed of the first conveying belts 72a and 72b and the second conveying belts 82a and 82b.

Means for solving the problems of the second embodiment are as follows.

[1] A sheet discriminating device including:

a first conveying structure and a second conveying structure that are arranged at a predetermined distance from each other in a conveying direction of a sheet and that are configured to convey the sheet;

an information detecting means that is provided between the first conveying structure and the second conveying structure and that is configured to detect information from the sheet;

a first guide member that opposes the information detecting means, is arranged such that the sheet can be inserted between the information detecting means and the first guide member, and moves from the first conveying structure toward the second conveying structure; and

a second guide member that opposes the information detecting means and is arranged so as to be located closer to the information detecting means than a detection limit position of the information detecting means is in a direction in which the second guide member opposes the information detecting means and located further away from the information detecting means than the first guide member is in the direction in which the second guide member opposes the information detecting means.

[2] The sheet discriminating device according to [1], wherein the first guide member is arranged such that the distance from the information detecting means when the first guide member oscillates in the direction in which the first guide member opposes the information detecting means with a maximum amplitude is greater than zero.
[3] The sheet discriminating device according to [1] or [2], wherein the first guide member includes a belt member that can come into contact with the sheet while being driven and rotated by at least one of the first conveying structure, the second conveying structure, and other driving means.
[4] The sheet discriminating device according to any of [1] to [3], wherein the first guide member is provided so as to overlap at least either of the first conveying structure and the second conveying structure in the conveying direction.
[5] The sheet discriminating device according to any of [1] to [4], wherein the second guide member is shaped such that the second guide member can restrict the position of the sheet only in a first region opposing the information detecting means between the first conveying structure and the second conveying structure and is spaced away from the sheet in a second region other than the first region.
[6] The sheet discriminating device according to any of [1] to [4], wherein the second guide member is provided at a predetermined distance from the information detecting means between the first conveying structure and the second conveying structure.
[7] The sheet discriminating device according to [6], wherein the second guide member is provided so as to overlap at least either of the first conveying structure and the second conveying structure in the conveying direction.
[8] The sheet discriminating device according to any of [1] to [7], wherein the first guide member includes a plurality of guide members that are arranged at a distance from each other in a direction that is orthogonal to the conveying direction of the sheet.
[9] The sheet discriminating device according to any of [1] to [8], including a third guide member that is arranged on an opposite side of a conveyance reference plane from the second guide member, the conveyance reference plane being set between the first conveying structure and the second conveying structure, such that the distance from the conveyance reference plane is equal to or greater than the distance between the conveyance reference plane and the information detecting means.
[10] The sheet discriminating device according to any of [1] to [9], wherein the information detecting means includes a magnetic sensor, and the second guide member is formed of a nonmagnetic or weakly magnetic metal.
[11] The sheet discriminating device according to any of [1] to [10], wherein the first conveying structure is arranged such that an entry angle of the sheet that is directed from an opposite side of the conveyance reference plane from the first guide member toward the first guide member and advances onto the conveyance reference plane from the first conveying structure is greater than zero, the conveyance reference plane being set between the first conveying structure and the second conveying structure.
[12] A sheet processing apparatus including:

the sheet discriminating device according to any of [1] to [11]; and

a sorting means that sorts the sheet conveyed by the first conveying structure and the second conveying structure in accordance with at least the information on the sheet that is detected by the information detecting means.

What is claimed is:

1. A sheet discriminating device comprising:
a first conveying structure and a second conveying structure that are arranged at a predetermined distance from each other in a conveying direction of a sheet and that are configured to convey the sheet; and
an information detecting means that is provided between the first conveying structure and the second conveying structure such that a detection range thereof is not blocked, and that is configured to detect information from the sheet,
wherein a first entry angle θ1 that is formed by a first entry direction in which the sheet enters a space between the first conveying structure and the second conveying structure from the first conveying structure and a conveyance reference plane that is set between the first conveying structure and the second conveying structure, and a second entry angle θ2 that is formed by a second entry direction in which the sheet enters the second conveying structure from the space between the first conveying structure and the second conveying structure and the conveyance reference plane are set to be equal to or less than respective predetermined values that depend on positions of the first conveying structure, the second conveying structure, and the information detecting means and a distance up to which the sheet is allowed to be separated from the conveyance reference plane at the position of the information detecting means.

2. The sheet discriminating device according to claim 1, wherein the first entry angle θ1 and the second entry angle θ2 satisfy the following formulae:
$$\begin{matrix}{θ}_{1} ≦ {tan}^{- 1} ( \frac{Yg}{{X}_{f 1}} ) & ( 3 ) \\ {θ}_{2} ≦ {tan}^{- 1} ( \frac{Yg}{{X}_{f 2}} ) & ( 4 ) \\ {θ}_{1} ≦ {cos}^{- 1} \frac{{X}_{f 1} + {X}_{f 2}}{\sqrt{{X}_{f 1}^{2} + {Yg}^{2}} + \sqrt{{X}_{f 2}^{2} + {Yg}^{2}}} & ( 5 )\end{matrix}$$
where X_{f1} is a distance from the first conveying structure to the information detecting means in a direction that is parallel to the conveyance reference plane, X_{f2} is a distance from the information detecting means to the second conveying structure in the direction that is parallel to the conveyance reference plane, and Yg is a conveyance position accuracy of the sheet in a direction of a normal to the conveyance reference plane, the conveyance position accuracy being required by the information detecting means.

3. The sheet discriminating device according to claim 1, wherein
the first conveying structure comprises a pair of first conveying rollers that are arranged offset from each other in the direction that is parallel to the conveyance reference plane, and a pair of first conveying belts that are respectively put around the pair of first conveying rollers so as to be turned back in a direction away from the second conveying structure,
the second conveying structure comprises a pair of second conveying rollers that are arranged offset from each other at an offset that is opposite to that of the pair of first conveying rollers in the direction that is parallel to the conveyance reference plane, and a pair of second conveying belts that are respectively put around the pair of second conveying rollers so as to be turned back in a direction away from the first conveying structure, and
the first conveying structure and the second conveying structure put the sheet in an unconstrained state between the first conveying rollers and the second conveying rollers.

4. The sheet discriminating device according to claim 3,
wherein a distance y1 between the pair of first conveying rollers in a direction that is orthogonal to the first entry direction satisfies the following formula:
d1+2×t1≦y1≦d1+2×t1+tp (1)
where d1 is an outer diameter of each of the pair of first conveying rollers, t1 is a thickness of each of the pair of first conveying belts, and tp is a thickness of the sheet, and
a distance y2 between the pair of second conveying rollers in a direction that is orthogonal to the second entry direction satisfies the following formula:
d2+2×t2≦y2≦d2+2×t2+tp (2)
where d2 is an outer diameter of each of the pair of second conveying rollers, t2 is a thickness of each of the pair of second conveying belts, and tp is the thickness of the sheet.

5. The sheet discriminating device according to claim 1, wherein at least either of the first entry angle θ1 and the second entry angle θ2 is zero.

6. The sheet discriminating device according to claim 3, wherein
the first conveying structure comprises a first roller which is arranged upstream of the pair of first conveying rollers in a conveying path of the sheet and engaging the pair of first conveying belts, the first roller applying a conveying force to the sheet via the pair of first conveying belts, and
the second conveying structure comprises a second roller which is arranged downstream of the pair of second conveying rollers in the conveying path of the sheet and engaging the pair of second conveying belts, the second roller applying a conveying force to the sheet via the pair of second conveying belts.

7. The sheet discriminating device according to claim 3, wherein
the pair of first conveying rollers comprise a near side first conveying roller that is arranged so as to be located closer to the second conveying structure and a far side first conveying roller that is arranged so as to be located further away from the second conveying structure,
the pair of second conveying rollers comprise a near side second conveying roller that is arranged so as to be located closer to the first conveying structure and a far side second conveying roller that is arranged so as to be located further away from the first conveying structure,
the pair of first conveying belts comprise a near side first conveying belt that is put around the near side first conveying roller and a far side first conveying belt that is put around the far side first conveying roller,
the pair of second conveying belts comprise a near side second conveying belt that is put around the near side second conveying roller and a far side second conveying belt that is put around the far side second conveying roller,
the near side first conveying belt is turned back by the near side first conveying roller in a direction away from the second conveying structure and then wound around the far side first conveying roller together with the far side first conveying belt that is turned back by the far side first conveying roller in a direction away from the second conveying structure, and applies a conveying force to the sheet together with the far side first conveying belt, and
the near side second conveying belt is turned back by the near side second conveying roller in a direction away from the first conveying structure and then wound around the far side second conveying roller together with the far side second conveying belt that is turned back by the far side second conveying roller in a direction away from the first conveying structure, and applies a conveying force to the sheet together with the far side second conveying belt.

8. The sheet discriminating device according to claim 1 further comprising:
a guide member that is arranged between the first conveying structure and the second conveying structure so as not to block the detection range of the information detecting means, and restricts the position of the sheet in a direction of a normal to the conveyance reference plane.

9. A sheet processing apparatus comprising:
a first conveying structure and a second conveying structure that are arranged at a predetermined distance from each other in a conveying direction of a sheet and that are configured to convey the sheet;
an information detecting means that is provided between the first conveying structure and the second conveying structure such that a detection range thereof is not blocked, and that is configured to detect information from the sheet,
wherein a first entry angle θ1 that is formed by a first entry direction in which the sheet enters a space between the first conveying structure and the second conveying structure from the first conveying structure and a conveyance reference plane that is set between the first conveying structure and the second conveying structure, and a second entry angle θ2 that is formed by a second entry direction in which the sheet enters the second conveying structure from the space between the first conveying structure and the second conveying structure and the conveyance reference plane are set to be equal to or less than respective predetermined values that depend on positions of the first conveying structure, the second conveying structure, and the information detecting means and a distance up to which the sheet is allowed to be separated from the conveyance reference plane at the position of the information detecting means; and
a sorting means that is configured to sort the sheet conveyed by the first conveying structure and the second conveying structure in accordance with at least the information on the sheet that is detected by the information detecting means.

10. The sheet processing apparatus according to claim 9, wherein the first entry angle θ1 and the second entry angle θ2 satisfy the following formulae:
$$\begin{matrix}{θ}_{1} ≦ {tan}^{- 1} ( \frac{Yg}{{X}_{f 1}} ) & ( 3 ) \\ {θ}_{2} ≦ {tan}^{- 1} ( \frac{Yg}{{X}_{f 2}} ) & ( 4 ) \\ {θ}_{1} ≦ {cos}^{- 1} \frac{{X}_{f 1} + {X}_{f 2}}{\sqrt{{X}_{f 1}^{2} + {Yg}^{2}} + \sqrt{{X}_{f 2}^{2} + {Yg}^{2}}} & ( 5 )\end{matrix}$$
where X_{f1} is a distance from the first conveying structure to the information detecting means in a direction that is parallel to the conveyance reference plane, X_{f2} is a distance from the information detecting means to the second conveying structure in the direction that is parallel to the conveyance reference plane, and Yg is a conveyance position accuracy of the sheet in a direction of a normal to the conveyance reference plane, the conveyance position accuracy being required by the information detecting means.

11. The sheet processing apparatus according to claim 9, wherein
the first conveying structure comprises a pair of first conveying rollers that are arranged offset from each other in the direction that is parallel to the conveyance reference plane, and a pair of first conveying belts that are respectively put around the pair of first conveying rollers so as to be turned back in a direction away from the second conveying structure,
the second conveying structure comprises a pair of second conveying rollers that are arranged offset from each other at an offset that is opposite to that of the pair of first conveying rollers in the direction that is parallel to the conveyance reference plane, and a pair of second conveying belts that are respectively put around the pair of second conveying rollers so as to be turned back in a direction away from the first conveying structure, and
the first conveying structure and the second conveying structure put the sheet in an unconstrained state between the first conveying rollers and the second conveying rollers.

12. The sheet processing apparatus according to claim 11,
wherein a distance y1 between the pair of first conveying rollers in a direction that is orthogonal to the first entry direction satisfies the following formula:
d1+2×t1≦y1≦d1+2×t1+tp (1)
where d1 is an outer diameter of each of the pair of first conveying rollers, t1 is a thickness of each of the pair of first conveying belts, and tp is a thickness of the sheet, and
a distance y2 between the pair of second conveying rollers in a direction that is orthogonal to the second entry direction satisfies the following formula:
d2+2×t2≦y2≦d2+2×t2+tp (2)
where d2 is an outer diameter of each of the pair of second conveying rollers, t2 is a thickness of each of the pair of second conveying belts, and tp is the thickness of the sheet.

13. The sheet processing apparatus according to claim 9, wherein at least either of the first entry angle θ1 and the second entry angle θ2 is zero.

14. The sheet processing apparatus according to claim 11, wherein
the first conveying structure comprises a first roller which is arranged upstream of the pair of first conveying rollers in a conveying path of the sheet and engaging the pair of first conveying belts, the first roller applying a conveying force to the sheet via the pair of first conveying belts, and
the second conveying structure comprises a second roller which is arranged downstream of the pair of second conveying rollers in the conveying path of the sheet and engaging the pair of second conveying belts, the second roller applying a conveying force to the sheet via the pair of second conveying belts.

15. The sheet processing apparatus according to claim 11, wherein
the pair of first conveying rollers comprise a near side first conveying roller that is arranged so as to be located closer to the second conveying structure and a far side first conveying roller that is arranged so as to be located further away from the second conveying structure,
the pair of second conveying rollers comprise a near side second conveying roller that is arranged so as to be located closer to the first conveying structure and a far side second conveying roller that is arranged so as to be located further away from the first conveying structure,
the pair of first conveying belts comprise a near side first conveying belt that is put around the near side first conveying roller and a far side first conveying belt that is put around the far side first conveying roller,
the pair of second conveying belts comprise a near side second conveying belt that is put around the near side second conveying roller and a far side second conveying belt that is put around the far side second conveying roller,
the near side first conveying belt is turned back by the near side first conveying roller in a direction away from the second conveying structure and then wound around the far side first conveying roller together with the far side first conveying belt that is turned back by the far side first conveying roller in a direction away from the second conveying structure, and applies a conveying force to the sheet together with the far side first conveying belt, and
the near side second conveying belt is turned back by the near side second conveying roller in a direction away from the first conveying structure and then wound around the far side second conveying roller together with the far side second conveying belt that is turned back by the far side second conveying roller in a direction away from the first conveying structure, and applies a conveying force to the sheet together with the far side second conveying belt.

16. The sheet processing apparatus according to claim 9 further comprising:
a guide member that is arranged between the first conveying structure and the second conveying structure so as not to block the detection range of the information detecting means, and restricts the position of the sheet in a direction of a normal to the conveyance reference plane.
